(19) United States
(12) Patent Application Publication
(10) Pub. No.: US 2014/0233914 A1
(43) Pub. Date: Aug. 21, 2014

(54) IMAGE APPEARANCE FRAMEWORK AND APPLICATIONS FOR DIGITAL IMAGE CREATION AND DISPLAY

(71) Applicant: Tektronix, Inc., Beaverton, OR (US)

(72) Inventor: Wayne Williams, Portland, OR (US)

(73) Assignee: Tektronix, Inc., Beaverton, OR (US)

(21) Appl. No.: 14/184,110

(22) Filed: Feb. 19, 2014

Related U.S. Application Data
(60) Provisional application No. 61/766,621, filed on Feb. 19, 2013.

(51) Int. Cl. G11B 27/031

(52) U.S. Cl. CPC G11B 27/031
USPC 386/280

(57) ABSTRACT

Embodiments of the invention provide tools that users may implement to quantify an artistic “Appearance” or “Look” of an image or set of images and carry the Look forward across multiple scenes of a collection. Additionally, the tools allow the same Look to be preserved when viewing the image or images on a wide variety of playback devices, such as cinema, television, computer monitor, and hand-held devices.

### CROSS REFERENCE TO RELATED APPLICATIONS

This application claims benefit from U.S. Provisional Patent application 61/766,621, entitled IMAGE APPEARANCE FRAMEWORK AND APPLICATIONS FOR DIGITAL IMAGE CREATION AND DISPLAY, filed Feb. 19, 2013, which is incorporated herein by reference.

### FIELD OF THE INVENTION

This disclosure is directed to digital imaging, and, more particularly, to systems for evaluating and modifying digital images and streams of digital images.

### BACKGROUND

While relatively easy to define from an artistic perspective, creating an artistic “Appearance” or “Look” and carrying it to the end-viewer is far from easy to achieve. Artistic Look is the use of color, tonal balance, and in and out of focus regions of an image to modulate the emotional response of a user in support of a story, or to create desire for a product in advertising. For example, in film, a film noir piece may include a purposely dark scene to convey mystery and danger, followed by a relatively light scene to convey a more uplifting mood. Artistic Look is an important component of the end-product and considerable effort is expended to in its creation. While appearance in the form of the artistic Look is part of the end-product, it is appearance itself that provides the most significant challenges in its creation. This is true for printed images and moving images viewed across multiple end-screens and viewing environments. A significant issue is that the appearance of an image, unless appropriately modified, will appear quite different when viewed on various projection devices or printed media and viewing environments. This is due to well documented appearance effects associated with adaptions, or changes in the sensitivity of the Human Vision System (HVS). These adaptions are triggered by variations in perceptual parameters associated with the viewing environment, devices or media, and the image itself.

For example, in the context of viewing moving images, appearance for end-viewers is determined by adaptive complex non-linear processing of the HVS of perceptual attributes of the viewing environment, the viewing distance and image size, and device capabilities. Furthermore, HVS processing is shaped by the interaction of these factors with the structure and temporal dynamics of an image or image sequence. Perceptual parameters of the viewing environment include the spectral composition of illuminating light sources and the color and brightness of the surround to the image. Perceptual parameters of the device include its producible gamut, dynamic range, and brightness. The implications of this is that, to convey the appearance of the intended artistic Look as close as possible to end-viewers across different display devices and viewing environments, content should be appropriately modified in mastering as it is transcoded to various distribution and device formats. Transcoding involves compression of the image sequence's gamut and dynamic range from the mastering format to a size appropriate to the mode of distribution and end-display devices.

Carrying the appearance of an intended Look to end-viewers means that perceptual image attributes important to the perception of an image or moving image sequence must be as close as possible to how it was seen by the artists who set that Look. These perceptual image attributes include the relative color appearance attributes of lightness, chroma, and hue, the absolute color appearance attribute of colorfulness, all of which is scaled by brightness. In addition, an image's achromatic tonal balance and chromatic balance across the image at suprathreshold response, and image sharpness at threshold response should appear as closely as possible as it was seen by the artists setting the final Look. Moving images add another dimension of complexity in that the image's temporal dynamics, such as motion blur, etc., carry to the end-screen. In this example, to carry an appearance match as closely as possible of these perceptual image attributes to the end-viewer, transcoding should be able to model and compensate for the adaptive appearance response of the HVS to the end-viewing environment and devices, and the image itself. Alternatively, a method to emulate and display the appearance of an image or image sequence which incorporates standard transcoding algorithms could be presented to the artist. Transcoding algorithms, or an emulation of an image's appearance at the end-screen, need to also account for preserving appearance as an image was seen in the color space and dynamic range of the format used in post-production, to the generally smaller color gamut and dynamic range specific to the mode of distribution and end-display devices.

The color workflow in place today is device-independent. This means that the image representation models used in devices and tools across the content creation workflow, including cameras, color and special effects software, format converters, etc., are able to inform color difference but not appearance. Modeling color difference coupled with characterizations of reference monitors and end-viewing devices allows for images to be acquired, modified to instill a Look, and adjusted for a specific output device. The limitations of the image representation models is that they cannot model the adaptive appearance effects of the HVS. This limitation drives inefficiencies as described in the example above, and across the content creation workflow from when a Look is first envisioned, and then realized through acquisition, post production, and mastering.

It is important to note that there is a hierarchy of meaningful appearance effects from the perspective of the end-viewer. An analogy can be made to listening to classical music. At a concert, any trained musicians in attendance will hear and appreciate the nuance of both the interpretation and performance of a given concerto. While this nuance would escape the untrained ears of most listeners, all listeners except those who are tone deaf would hear if the performance were off-key. A similar situation holds true for images. People watching television who have a background in film lighting or any form of color work will see and appreciate the nuances of intended appearance while others may not. Most all viewers would appreciate the difference between an image that is washed out due to a combination of viewing environment and poor television set-up, versus seeing that image with its intended dynamic range and tonal balance. The same holds true for optimizing exposure for cameras. Most viewers can appreciate the difference of an image that is well exposed versus one having blown out highlights or that is too dark. A cinematographer or professional photographer will further appreciate the ability to place different scene elements at particular points along the available contrast curve within the dynamic range of their cameras using the well-known Ansel Adams zone system.

As imaging, in both cinema and television, is moving from physical film to file-based in media across the workflow, it is becoming increasingly difficult to carry a Look as it evolves across the workflow because of the wide range of possibilities of creating and manipulating in a digital context. The intention and use of artistic Look in content remain the same as it was with film in that a cinematographer, director, colorist, etc., develop a Look within the work to evoke different emotions in the viewer. It is the methods and techniques of how to achieve the Look that has changed with the transition from film to digital. In film-based acquisition, cinematographers selected film stock for a desired Look based on an understanding of how it modulated light to film density in terms of its sensitivity, graininess, and compressive profile. Through experience, they also had a good sense of how this would ultimately appear to end-viewers with film-based projection in the cinema, based on an understanding of well-established “recipes” across the workflow. With digital sensors, cinematographers have the ability to modify color, sensitivity, and gamma of their cameras in ways not possible with film to optimize for a desired Look. But this flexibility comes at a cost in that it changes or even “breaks” well established recipes from film-based acquisition making it difficult to determine optimal camera settings and lighting placement. Waveform Monitors, which can be used with digitally acquired moving image content, are able to inform the calibration of cameras to a working acquisition color space, but they cannot inform appearance and thus cannot assist with optimal set-up in terms of appearance. Reference monitors are the reference for image appearance across the workflow, but they are only accurate in conveying image appearance within its producible gamut and dynamic range in the viewing environment it is set up in. As will be described, appearance-related issues impact creators, directors, and producers of modern works from pre-visualization to the end-screen. This includes camera set-up and camera balancing, exposure, focus, conveying a Look from acquisition to post production, scene matching, ensuring image consistency across multiple geographically distributed seats as content is edited, color graded, with applied special effects, and then accurately transcoding content at the mastering stage so it can be seen as intended when viewed in a theater, on a television, on a computer display, or on a mobile viewing device such as a tablet or smart phone. All of these issues are appearance related, and the challenges are a consequence of the inability of present tools to effectively model HVS and adaptions thereof.

Embodiments of the invention address these and other issues in the prior art.

### BRIEF DESCRIPTION OF THE DRAWINGS

FIG. 1 is a diagram showing typical creation and presentation work flow in digital imaging.

FIG. 2 is a diagram that illustrates issues impacting modern moving image production.

FIG. 3 is a diagram that illustrates the details of the human vision system appropriate for these applications.

FIG. 4 is a diagram that illustrates two key adaptions occurring with retinal image processing.

FIG. 5 is a diagram illustrating the variation in luminous energy encountered from capture to display for an example workflow.

FIG. 6 illustrates gamut compression and expansion to map a source color space to a destination color space.

FIG. 7 illustrates external perceptual parameters that trigger adaptive appearance effects.

FIG. 8 is a diagram illustrating the variations of image gamuts and dynamic range of the distribution color space, device, and the image itself.

FIG. 9 is a diagram illustrating device coordinates, device independent coordinates, and viewing environment independent coordinates image representation models.

FIG. 10 is a diagram that illustrates a representative device independent color workflow in practice today.

FIG. 11 shows the categories of tools-in-use across the content creation workflow specific to moving images

FIG. 12 is a diagram that illustrates an Image Appearance Framework according to embodiments of the invention.

FIG. 13 is a diagram that illustrates applications that the Image Appearance Framework of FIG. 12 may address.

FIG. 14 is a diagram that illustrates components of an Image Appearance Monitor constructed from modules of the Image Appearance Framework of FIG. 12, and additional functional components according to embodiments of the invention.

FIG. 15 is a diagram that illustrates an example physical implementation of the IAM functions illustrated in FIG. 14 according to embodiments of the invention.

FIG. 16 is a diagram that illustrates a hierarchal relationship between the presentation layer, the image appearance operations and qualifications, and the image appearance model according to embodiments of the invention.

FIG. 17 is a diagram that illustrates an example of the functional interrelationship of the presentation layer and image appearance qualifiers and operations applied to scene matching in post-production according to embodiments of the invention.

FIG. 18 illustrates the main image appearance processing flow and architecture according to embodiments of the invention.

FIG. 19 illustrates example images shown on an image appearance monitor of the image appearance display in the image display mode having various lightness qualifications applied to them according to embodiments of the invention.

FIG. 20 illustrates options for mapping solid colors or gradients to image pixels of the image appearance display in the mapped color mode corresponding to applied qualifiers and operations according to embodiments of the invention.

FIG. 21 illustrates an example of the utility of gradients in the mapped color mode to inform optimum camera exposure and lighting placement for a given scene according to embodiments of the invention.

FIG. 22 illustrates a reference image and an image to match to the reference image represented in the image appearance display in the image display mode according to embodiments of the invention.

FIG. 23 illustrates the vertically and horizontally uncorrelated option of the image contrast mode for the image appearance display according to embodiments of the invention.

FIG. 24 illustrates the vertically and horizontally uncorrelated option of the image contrast mode for the image appearance display for the reference image and the image to match according to embodiments of the invention.

FIG. 25 illustrates a side by side comparison of the reference image and the image to match to the reference image using the vertically and horizontally uncorrelated option of the image contrast mode for the image appearance display according to embodiments of the invention.

FIG. 26 illustrates the image appearance difference of the reference image minus the image to match which is displayed in the horizontally and vertically uncorrelated of the image contrast mode for the image appearance display according to embodiments of the invention.

FIG. 27 is an example image viewed in an image detail mode of the image appearance display that illustrates qualified regions of perceived sharpness according to embodiments of the invention.

FIG. 28 illustrates the synchronization of the light display and color displays, both of which are portions of a presentation layer according to embodiments of the invention.

FIG. 29 illustrates an example of adjusting the light and color displays for three different projections according to embodiments of the invention.

### DETAILED DESCRIPTION

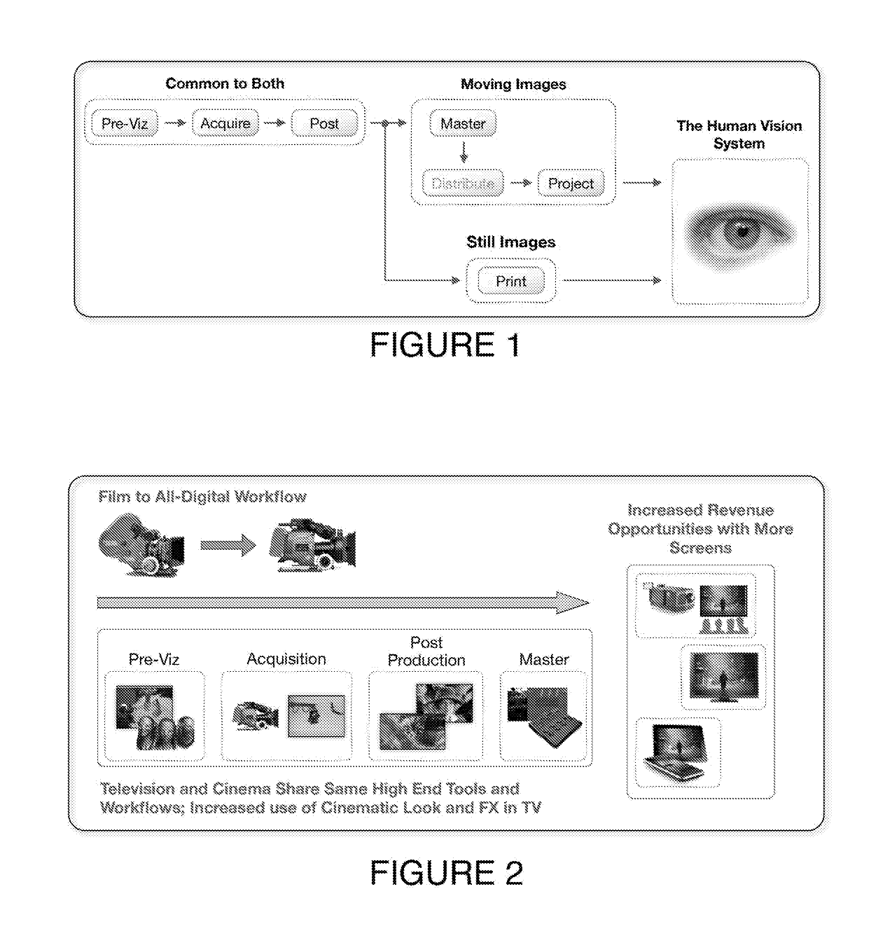

A general scene-to-screen workflow is shown in FIG. 1 for the creation and presentation of both moving and still images. The focus in this writing is digital content creation for moving images, as it is the most complex, and issues and solutions that are distinct for print will be noted.

An appearance or look is conceptualized in Pre-Visualization and tools and methods to be used in production to realize a Look are planned in advance as much as possible to mitigate the high cost of production. PHOTOSHOP, an image editor for computers made by Adobe Systems, Incorporated of San Jose, Calif., may be used to establish an initial concept of desired artistic appearance. Look Up tables (LUTs), which carries the colorimetry of the image as seen on a calibrated and characterized monitor may be used to carry that Look to production. For special effects the marks and points an actor moves through in a blue-screen shooting are carefully planned. A rough Computer Graphics (CG) build of the virtual environment that actors move through might be constructed. This virtual environment is superimposed over actor blue-screen shooting in production to ensure proper movement of the actors. The selection of a camera is even more important now compared to the time when the camera and the physical medium, film, to acquire content was decoupled. This is because the camera sensor takes the place of the film. Equipment houses will generally perform an advance calibration of selected cameras and lenses prior to production.

Acquisition plays a major role in establishing and enabling the final appearance of a Look. This Look is set through lighting and set-design and digitally acquired footage using either cinema or High Definition (HD) cameras, or Digital Single Lens Reflex cameras (DSLRs). One of the most significant issues is to accurately place scene elements within and along a camera's dynamic range in support of a desired Look. Ideally, this could be performed such that this placement of scene elements along a given contrast curve could be optimized as to how it would appear to end-viewers across one or more end-displays and viewing environments. This involves achieving the right mix of optimally shaping the compressive profile of a camera via adjustments to gamma at a given gain and Iris, lens selection, and the placement, quality, temperature, and intensity of lighting. One challenge with digital acquisition is related to the inability of tools to inform these factors based on how content will appear. This holds for accurate appearance on on-set monitors or as it would appear down-stream in the workflow or even at the end-screen. Another issue is to achieve accurate focus with high resolution image formats that exceed on-screen monitor optics and viewing geometries of the assistant camera operator to the monitor. Finally, it is desired to ensure that acquired footage enables a desired Look in dailies and to convey the cinematographer's intended Look to post production. For the latter, tools such as color decision lists, metadata specifying color adjustments made to the image with color grading at production, or Look LUTs are used to carry a Look from production to post production. But these are device independent implementations and thus cannot accurately carry appearance.

In relation to appearance, post production takes acquired footage and instills a final Look through adjustments to the image in color grading and special effects. With still images for high-value content, such as advertisements, PHOTOSHOP is a de facto standard for post-production. For lower-value economic content, such as wedding photography, LIGHTROOM, also by Adobe Systems and APERTURE by Apple, Inc. of Cupertino, Calif. offer a simpler workflow.

For moving images for cinema and television, common post production applications include special effects “FX,” and color grading. In color grading, the artist sets the appearance with selected scenes, and then then carries that appearance as loosely or tightly as desired across clips for scene matching, and the entire film to shape the arc of the appearance. An issue that affects color grading is scene matching. After the artist sets the Look for selected scenes, it is tedious to carry the appearance of that Look across clips. For a given project 30% of the time might be dedicated to setting a Look and then 70% of the time is spent carrying that Look across scenes and the film as a whole. Tools that could better enable scene matching that could improve this part of the process would add value under tight schedules. For high-value production, tools that facilitate carrying the appearance of a Look across scenes but leave the controls in the hands of the artists is best. For lower budget productions or photography, automated tools to adjust clips would be of benefit. Special effects are increasingly used in television to help differentiate commercials and in high-value episodic television, but tight production schedules necessitates a parallel process to instill effects in content. This can involve tens of seats that are likely geographically dispersed. The challenge, as noted above, is in managing image appearance consistently across distributed FX development seats, and color and editing seats.

With reference back to FIG. 1, after Pre-visualization, acquisition, and post-production steps are performed, the paths diverge between moving and static/still images.

With printed media, a soft proof is typically used to emulate how the image will look on a specific paper and ink combination. The soft proof may use a profile to characterize the physical rendering of color through the chemical interaction of paper and ink. The image representation model used by PHOTOSHOP is a proprietary version of CIE LAB (International Commission on Illumination 1976 definition of color space). CIE LAB is a device independent image representation and is thus unable to model HVS adaptions. This is why a print often looks quite different than what was carefully constructed on the monitor using PHOTOSHOP unless it is viewed under lighting corresponding to a D50 illuminate and set against a white to middle grey surround.

With digital content, the mastering format used in post production is transcoded to a distribution format appropriate for the mode of distribution and the end-devices. These formats typically involve a compression of the gamut, dynamic range, and resolution of the format used to set the Look in post production. Today's device-independent tools do not provide the capability to carry a Look to various end-screens and devices which can account for the adaptive appearance effects associated with compression, the end-viewing environment and devices, and the image itself. This is what drives a separate color grade for each major category of end-screens. The objective is to enable end-viewers to see the appearance of the intended final Look as closely as possible. In fact, addressing this issue in mastering is described as one of the industry “holy grails” captured by the phrase “grade once, transcode many”.

Additionally, content must be checked to ensure it is in compliance with the distribution and device color space gamut, but this is an area that is well served by waveforms.

Once created, the work is shown on digital displays or printed media. The color workflow in place today is device independent, requiring end-viewing devices or media to be both calibrated (devices only) and characterized. While the specification of Digital Cinema Initiatives (DCI) provides a well characterized description of the digital projection devices and viewing environment for digital cinema, television and mobile devices are more loosely defined. With television end-consumers typically do not know how to properly set up their devices and manufacturers will often add some form of video processing, all of which further complicates the goal of carrying an intended appearance to end-viewers which is already handicapped by a device-independent workflow. As will be described below, to assist with managing image appearance “scene to screen,” what is needed are tools that work on an image representation model that extends the present device independent color workflow to also provide viewing environment, moving image, color space, and dynamic range independence. In other words it can model the adaptive appearance effects associated with these factors.

FIG. 2 is an image that illustrates issues impacting modern moving image production that set the context for the current image appearance challenges described above. The most significant issue is the transition from film to digital. The latest generation of digital cinema cameras meets and even exceed the capabilities of film in terms of gamut and dynamic range. Thus, film is an artistic, as opposed to required choice. Workflow advantages, including decreasing cost and processing times, have swung the pendulum heavily in the direction of digital.

The same issues relating to image appearance existed when film was the medium to acquire and carry the image. But over years of accumulated knowledge and practice the process was “gamed” to adjust images to a somewhat satisfactory degree in relation to creating a carrying the appearance of a Look.

For example, in production, the tools used by a cinematographer to create an appearance were lighting set-up, lens selection and a judicious selection of film-stock. Film was well characterized in terms of its modulation of light energy to film density. The most important attributes to consider were sensitivity to light, the compressive profile, and the size of the film grain. Shaping contrast across scene elements was managed using spot readings with a light meter to measure and manage contrast ratios based on the Ansel Adams Zone system.

The manufacturers of film built in a compressive profile that took into account diminished perceived contrast in a theatre resulting from a human vision system that is shifted to be more sensitive in a darkened environment. The consequence of this heightened sensitivity to luminous energy is that it “lifts” darker colors without impacting lighter colors, thus diminishing the overall perceived image contrast. Film had a power law gamma of 3.6, which brightens darker colors to place them in a luminance range more consistent with how they would be perceived in a dark theatre. While this was directionally correct, perceived HVS broadband image contrast has more variation then what is captured by a “one size” power law compression.

Today, with all-digital workflows in use for both cinematic and televised content, the physical transduction of light energy to film density is replaced by digital sensors. The positive aspect of this is greater flexibility in shaping an appearance by the way in which the sensitivity and compressive profile can be adjusted in camera, with the results immediately visible on a calibrated reference monitor. The cost of this flexibility is that established “recipes” for film-based content creation were upended. At acquisition this is illustrated by the three different approaches taken by the most influential manufacturers of high end digital cinema cameras. The ALEXA digital camera by ARRI of Munich, Germany, attempts to carry the experience as transparently as possible from film to digital by providing sensors with a film based compressive profile and limiting the ability to modify this profile or gamma. The EPIC digital camera from Red Digital Cinema Camera Company of Irvine, Calif. takes an approach familiar to still DSLR shooting by acquiring the raw linear light to sensor data, which is converted to video at a subsequent stage. This delays the application of a white point and compression to post production. This is thought to preserve more options at post, but they are still constrained by the ways in which acquisition was not optimized. This has to do with making adjustments to lighting and placement of scene elements and camera based on a known compression to be applied. In essence, with a raw workflow, cinematographers are not able to see what is being captured which can be frustrating. The Sony F65 from Sony Corporation of Japan provides compressive profiles emulating film but also enables a multitude of adjustments to camera gamma. Other issues shown in FIG. 2 include: a continued focus on providing visually rich content for high-value productions, which garner the majority of consumption dollars; Television and Cinema now share same tools and workflows. This enables increased use of cinematic look and special effects in television, but it drives more complexity to create content on an episodic television production schedule.

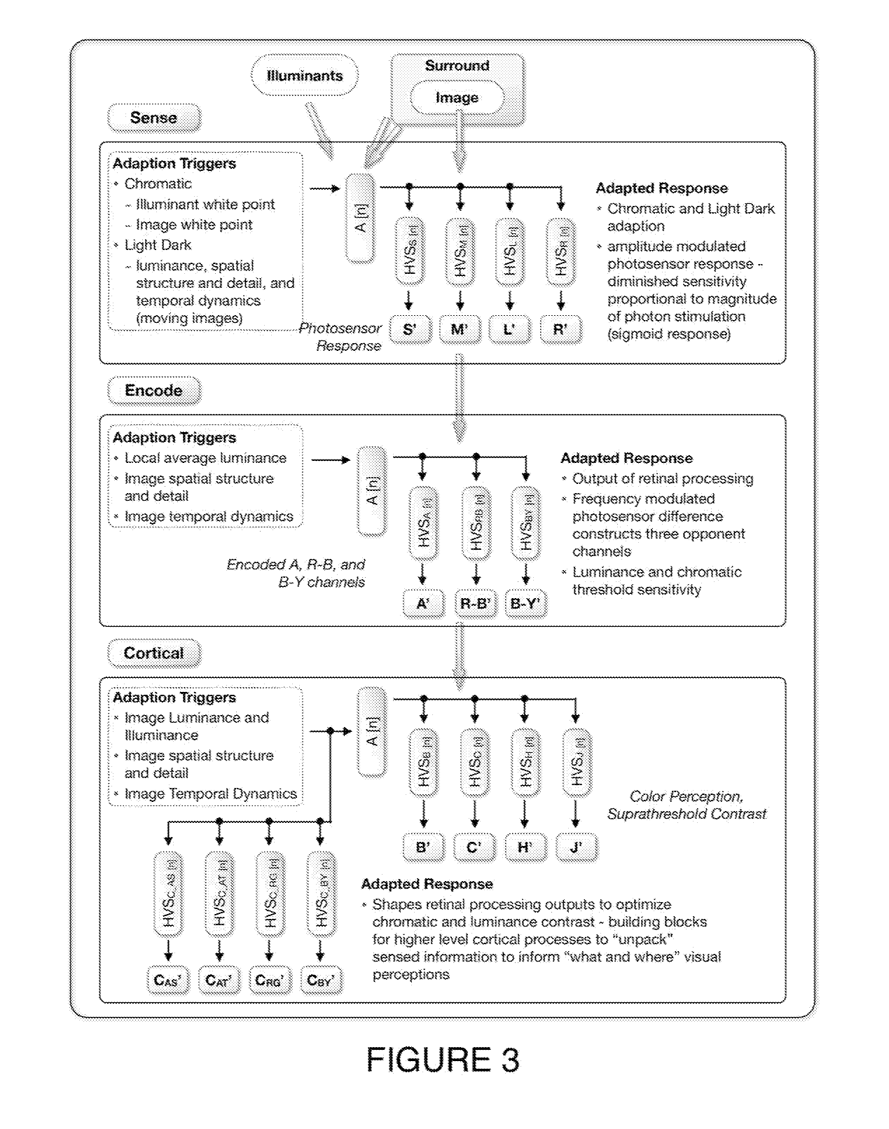

FIG. 3 illustrates details of the human vision system “HVS,” which is remarkably efficient in adapting its sensitivity to changes in the spectral composition and energy of the external environment, and then processing and compressing sensed information for cortical processing where visual perceptions are ultimately formed. It is the inability of current image representation models in tools used across content creation to model these adaptions that is at the core of workflow challenges. Thus, providing a more accurate appearance model capable of modeling relevant adaption appearance effects of the HVS for content creation is the area where the biggest contributions can be made.

First described are image appearance attributes, which are important to replicate the appearance of an image as it appears in different viewing environments and display devices or physical media. Then, adaptive HVS processing relevant to content creation and the end-viewing environment are described.

For systems playing a role in the creation and carry-forward of an appearance, a definition of artistic appearance is useful in terms of image appearance attributes that can be modeled. From extensive work done in color appearance research culminating in the color appearance model CIE CAM02, the latest color model ratified by the CIE, color appearance attributes are well defined and understood. These include the relative color attributes of chroma, hue and lightness, and the absolute color attributes of brightness and colorfulness. There is broad consensus that for colors to match in appearance viewed in different environments and devices, it is necessary, but not sufficient, that the relative color appearance attributes should be similar. An example where this falls short is driven by differences in brightness, which impacts perceived lightness, hue, chroma and colorfulness, of display devices and therefore has significant impacts on appearance as described in the section on HVS adaptions.

The attributes defined in CIE CAM02 have served the color matching industry well, but for complex still or moving images, additional appearance metrics are required. Adaptive appearance effects result from an image's spatial structure and frequency, and for moving images its temporal dynamics. These appearance effects include global image suprathreshold achromatic and chromatic contrast, and perceived image sharpness (threshold contrast). Chromatic contrast is complicated in that it shifts from amplifying color differences at low spatial frequency to blending color differences at higher spatial frequencies. All of these forms of contrast can be thought of as the rate of change of an attribute of the image such as its perceived tonal balance, sharpness, or color. Differences in viewing distance and image size also have a significant impact on appearance including perceived image sharpness, and tonal and chromatic balance. Viewing geometries are highly relevant for content that might be viewed in the cinema or on a smart phone. Color appearance models such as CIE CAM02 were developed and tested with simple “images” comprising one or a few color patches with the surround represented as a single color but does not provide a mechanism to incorporate complex image parameters as described above. iCAM is an image appearance model proposed for complex still images. Some of the relevant shortcomings of iCAM include the inability to model appearance effects associated with moving images and the effects of viewing geometries.

Therefore, for still or complex images, it would be helpful to extend color appearance attributes to include a characterization of broadband image chromatic and achromatic suprathreshold contrast and threshold contrast in the manner in which humans perceive it.

These image attributes can be characterized by two forms each of chromatic and achromatic contrast. These contrast characterizations are intended to represent the processing of retinal outputs, which only processes local differences, in the first stages of cortical processing. This incorporates global and local image aspects to construct a retinotopic map for each eye comprising the basic visual building blocks, including the forms of contrast described above to generate edges and their orientation, texture, etc., which are processed by higher cortical processes to form percepts. For the purposes of image appearance, binocular vision is not addressed.

The dynamic range of the output of retinal processing at a given state of adaption is roughly 10² while scene luminance can vary over the range of 10¹⁰. Thus, cortical HVS processing needs to efficiently allocate perceived achromatic and chromatic differences of image elements and of the image as a whole as efficiently as possible within this limited dynamic range. The four forms of contrast described below describe different aspects of image differences to enable an optimal utilization of this dynamic range in support of the main objectives of the HVS, which is to inform what is out there and where it is.

Luminance based broadband image suprathreshold contrast describes how we perceive the image as a whole in terms of the distribution of dark and light areas across the image. This is often referred to as an image's tonal balance by artists. Peli, in “Effect of luminance on suprathreshold contrast perception” by E. Peli, J. Yang, R. Goldstein. Reeves, J. Opt. Soc. Am., August 1991, Vol. 8, No. 8, pp. 1352-1359, discusses issues in quantifying the perceived broadband dynamic range in complex images and conducted experiments providing valuable psychophysics data. His work illustrated the relationship of perceived broadband image contrast to spatial frequency and image structure (the distribution of detail across an image). He found that the distribution and amount of image detail and spatial frequency in cpd, cycles per degree, across the image influences how the broadband image contrast is allocated by the HVS, which in turn shapes perceived image contrast. One possible explanation for this is that the HVS allocates more of a finite suprathreshold contrast “budget” to more detailed parts of a scene in support of object recognition.

Luminance based threshold contrast refers to the acuity of the HVS to resolve differences in high spatial frequency regions of an image. This occurs in fixed versus roaming gazing. What is essentially a spot detector in the ganglion network becomes edges and texture with base-cortical processing within a retinotopic map. Sensitivity is derived from the concentration of photosensors in the fovea which provides a maximum acuity of the HVS for a given object in the region subtended by a 2° viewing angle. The limit of HVS acuity occurs at approximately 60 cycles per degree (cpd).

Chromatic contrast can be described by red-green and blue-yellow opponent contrast. Color is not generally used to identify objects but rather helps humans determine qualities about the object. For example, color enables humans to determine if fruit is ripe, but not identify an object as a fruit. Thus chromatic sensitivity has a low-pass characteristic with respect to image frequency. For example, the perception of two colors interspersed with each other at a low spatial frequency are amplified (increased chromatic contrast) through a mechanism known as simultaneous contrast. At higher spatial frequencies they appear to blend, which is described as spreading. This effect is most pronounced along opponent color dimensions. Thus perceived chromatic contrast, and in this case hue, changes with differences in spatial frequency across the image. Given the function of color in the HVS enhanced chromatic contrast at higher spatial frequencies would waste finite visual processing resources.

A characterization of these forms of perceptual contrast are in the form of the perceived rate of change of color and light differences across the plane of the image for a given contrast type.

An important but difficult to achieve goal is the desire to carry the appearance of an image or image sequence across the content creation workflow and to the end-screen. An image at different points is more likely to be perceived as similar if both relative color appearance attributes and the chromatic and achromatic forms of contrast described above appear similar. An additional requirement is the need to account for brightness, which impacts relative color appearance attributes and colorfulness, and also impacts perceived chromatic and achromatic image contrast. Image brightness varies significantly across the content creation workflow. It starts with the dynamic range physically present in a scene, its compressed form in the dynamic range a camera can capture, the brightness levels set for monitor calibration in post-production and mastering, and then adjusted based on the luminance a device can generate, or that paper will reflect at the final point of display. Image representation models in-use do not incorporate perceived complex image contrast or the effects of variations in brightness, limiting their efficacy to achieve this goal.

FIG. 3 illustrates a simplified functional diagram of human vision including retinal and base cortical processing. These are the components that are important to model of the HVS to inform image appearance attributes described above in the context of the applications of content creation and end-viewer presentation. This diagram illustrates adaption triggers and adapted responses for the illustrated functional blocks of the HVS. Adaption triggers are parameters corresponding to aspects of the external environment or internally generated perceptual parameters, as an image is processed by the HVS that modify a given HVS response. This simplified model of HVS adaptions and responses provides a framework to both illustrate issues with current tools in modeling appearance and to describe the proposed solution. In FIG. 3, A[n] represents changes in the sensitivity of HVS response as a function of the image itself and parameters specific to a given point of HVS processing. HVS[n] represents the processing of perceptual inputs to adapted outputs with its response modulated by the outputs of A[n].

Retinal processing occurs within the retina and includes the functions of optically sensing and then encoding local contrast differences of incoming light. Spectral light energy is transduced to amplitude modulated photochemical energy, and then encoded to an achromatic and two opponent color channels which is then transmitted to the lateral geniculate in the thalamus via the optic nerve.

Cortical processing is extremely complex and modeling its entirety is well beyond what is possible or necessary for the purposes of carrying image appearance for the applications described. There are, however, important aspects of base-cortical processing to be considered. Specifically this includes the processing of the outputs of the lateral geniculate to construct a retinotopic map for each eye which preserves the relative spatial information of photosensors and allocates achromatic and chromatic suprathreshold and threshold contrast within a given state of adaption. This also includes color attributes, edge detection and orientation, and pattern detection. These form the basic visual building blocks processed by higher levels of cortical processing to form percepts from which our visual perceptions emerge. The ability to model adapted response of these perceptual building blocks would make a significant contribution to the applications described.

In FIG. 3, adaption triggers and adapted responses within the functional blocks of Sense, Encode, and Base-Level Cortical are described in more detail below.

Sense—Photosensors within the human eye transduce photons to amplitude modulated photochemical energy through three cone types and rods that have different spectral sensitivities. Rods are more sensitive to light than cones, while cones provide trichromatic spectral differentiation which enables the construction of the color gamut we are able to perceive and out acuity.

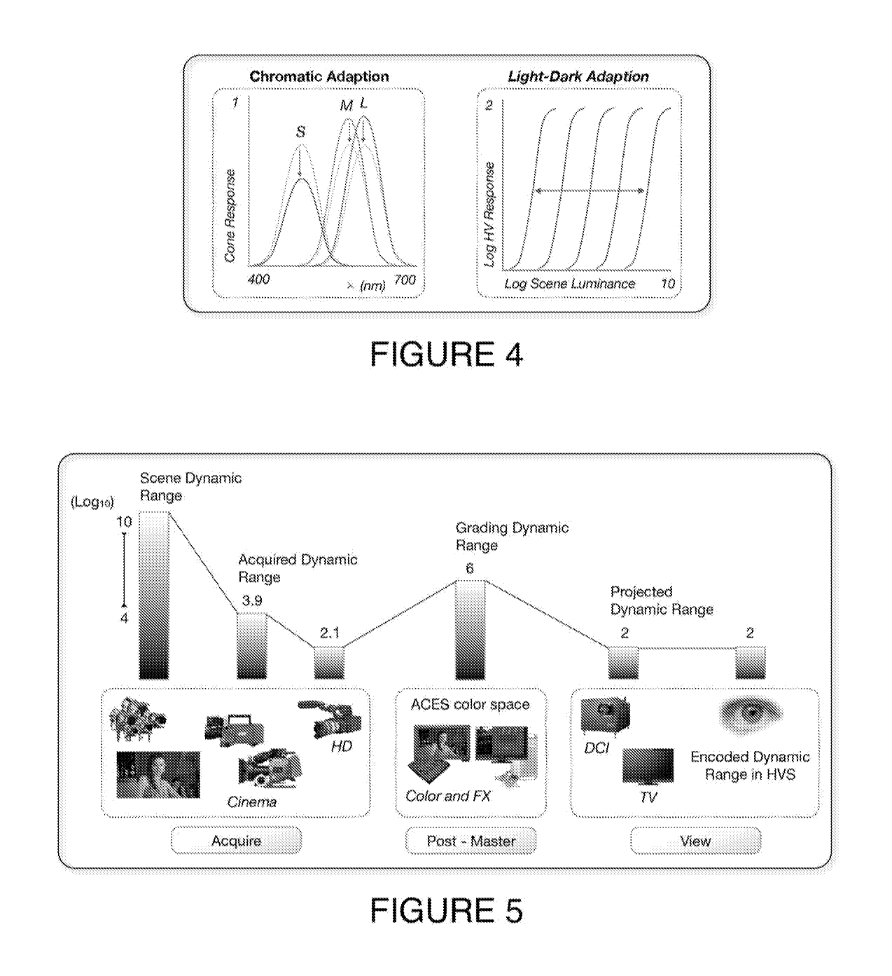

FIG. 4 is an image that illustrates two key adaptations that occur with photosensors in the eye at this stage. Chromatic adaption can be thought of as independent gain control of the S, M and L (Short, Medium, and Long) cones, which enables color constancy. Changes in the relative sensitivities are driven by cortical processes based on color memory and requires the presence of illuminating light sources and illuminated objects. Thus, in a dark theatre with negligible external lighting, the HVS lacks the clues relating to the spectral power distribution of illuminating light sources to trigger the appropriate response. The adaption trigger is the spectral power distribution of illuminating light sources in the viewing environment.

Light-Dark adaption is the adaption to external luminous and illuminant spectral energy. In order to provide high acuity across environments that can range up to 10¹⁰ in luminous energy, the HVS limits its dynamic range to 10² at a given state of adaption. To accommodate environments of differing spectral intensities the HVS effectively slides its 10² response across a 10¹⁰ range as illustrated in FIG. 4.

Photo sensor outputs are summed and processed in the ganglion network in a center-surround antagonistic manner. This provides local achromatic and opponent colors difference as outputs via three channels into the optic nerve. These channels are an achromatic response and opponent red-green and blue-yellow responses. This center-surround architecture sets the limits of encoded luminous and chromatic threshold contrast and is driven by local versus broadband image differences. Adaptions take the form of changes in sensitivity of chromatic and luminous threshold response based on viewing geometries, image spatial and temporal frequency, and average local luminance.

Base Cortical Processing Retinal processing output is sent through the optic nerve and is received at the Lateral Geniculate Nucleus (LGN) in the thalamus, mirroring the outputs of the ganglion network. It acts as both a relay station but it is also believed that cortical feedback to the LGN shapes what is sent to the visual cortex.

The first stage of cortical processing takes the achromatic, red-green, and blue-yellow threshold differencing outputs of retinal processing to build the basic visual building blocks within retinotopic maps for each eye. Chromatic and achromatic suprathreshold and threshold contrast is optimized to inform the primary “what” (objects) and “where” (where are objects, navigation, manipulation of objects) functions of the HVS. These visual elements include the manner in which a finite contrast range is optimized as described above. Whereas retinal processing is limited to local differences effects, global image differences are accounted for and constructed at this stage. These contrast optimizations underlie well documented adapted responses including simultaneous contrast, crisping, spreading, etc.

Object recognition is achromatically based and is served by the cognitive spatial construct known as retinotopy which preserves the ordinal spatial orientation of retinal photosensors and achromatic threshold contrast. From achromatic threshold contrast edges, orientation and pattern are constructed from what is essentially spot detection in the ganglion network of the retina. Color does not inform what objects are and thus has a low pass sensitivity.

Successfully characterizing and modeling these contrast forms are important to carrying image appearance enabled by several key image appearance operations such as an appearance difference of frame identical or different images for the applications of content creation and display. The perceptual attributes important for these applications include adapted color appearance attributes of hue, chroma, colorfulness, lightness, and brightness, and the four adapted contrast forms described above to model the perceptual dynamics of color and luminance contrast in complex images. Adapted HVS response that impact image appearance as described are a non-linear function of the overall image structure, spatial and temporal frequency, the viewing environment, device or media characteristics, etc.

Cortical processes, which include feedback to the sensitivity of photosensors to adjust such that white appears white under different illuminant spectral power distributions is accounted for enabling color constancy and is described as chromatic adaption.

In summary, adaptation triggers, or adapted response of the HVS which impacts appearance include image luminance and illuminance, image spatial structure, and spatial and temporal frequency, perceptual viewing environment parameters, display or printed media characteristics, and viewing geometries. Adapted mechanisms of the HVS include chromatic adaption, light-dark adaption, suprathreshold and threshold contrast, edge detection and orientation, and texture. Examples of appearance effects resulting from these adaptions include simultaneous contrast, crisping, spreading, perceived sharpness, and chromatic and achromatic tonal balance.

Next, these effects of HVS adaptions in content creation and display are described.

The core appearance issue in content creation is that the “same” image will appear different due to adaptions of the HVS in response to different conditions set up by device or printed media characteristics, viewing conditions, and the image structure and dynamics as described above. Some of the concepts described herein are explained in U.S. patent application Ser. No. 13/340,517, entitled Method of Viewing Virtual Display Outputs, by Kevin M. Ferguson, which is incorporated by reference herein.

What follows are the most important appearance effects triggered by HVS adaptions in content creation, which, if not properly managed, impact appearance in ways ranging from dramatic to subtle as described above. Appearance effects relating to HVS adaptions can be categorized in two main categories, issues in creating content, and issues in viewing content at the end-screen or printed media.

Issues in creating content. These issues play out within and across each of the main applications from pre-visualization through mastering. These can be broadly categorized in two areas—optimizing the compression of luminance and image focus in acquisition, and carrying a Look across the workflow and within each of the major workflow applications.

In acquisition, two important issues in addition to carrying a Look, which are described below, have to do with optimizing the compression of scene luminance specific to a desired Look through the activities of camera set-up and lighting and achieving accurate image focus as camera optics and sensors support increasingly higher resolution formats including 2K, 4K and even 5K.

The settings of camera, lens selection, and lighting all play an important role in optimizing the compression of the spectral power distribution of a scene for a finite dynamic range of a camera. The dynamic range of a camera is gated by both its optics and sensor. The optics compress the dynamic range through lens flare, which randomly adds light across the image, and diffraction, which diminishes brightness by dispersing photons described by point-spread functions. A sensor limits dynamic range by sensor saturation on the bright end and in the form of noise for the blacks. Modern optics and sensor systems can achieve an impressive dynamic range perspective compared to standards set in HD broadcast and which are starting to exceed that of film. For example, the ARRI ALEXA camera has a dynamic range of 13 stops. While 13 stops can start to encompass the dynamic range of some scenes without sunlight, it is still a power law compression and cinematographers need control over how scene elements are placed along a given contrast range.

Sensors respond in a linear manner to light. For non-raw workflows, a power law compression is applied to sensor output appropriate to the working color space, which is 2.2 for HD broadcast or 2.6 for cinema. This profile, referred to as gamma, describes the allocation of contrast within the finite dynamic range of the camera's sensor, optics, and processing system. Digital sensors provide the flexibility to shape the profile of compression by selecting different power law exponents and for a given power law exponent, i.e., the ability to modify the “knee” and the “toe,” which shapes the response for highlights and shadows respectively. This is done to support an overall Look in the form of tonal balance including a high versus low contrast image or a high versus low key image. A high key image means that overall perceived brightness is brighter than middle grey and a low key image means that overall perceived brightness is darker than middle grey. It is also desirable to manage the placement of scene elements across the contrast range in support of the artistic Look.

What is desirable is to optimally shape the profile of compression and placement of scene elements along this contrast curve based on appearance and in particular how it will appear to viewers across various end-screens. The various factors impacting the appearance of image contrast include image brightness and spatial structure and frequency. The ability to emulate how the image would appear at the end-viewing environment would ensure that contrast across the image is optimized as it would appear for end-viewers. Waveform monitors, which are device coordinates based, are unable to inform adjustments to a camera's gamma, gain, and exposure, and lighting based on any of the appearance attributes described.

With raw workflows these objectives are more difficult to achieve because sensor data does not have a gamma and white point applied until it is processed after it has been acquired. This follows the workflow in still image photography, however cinematographers are often frustrated because that they do not “see” what they are capturing on reference monitors. The flaw in this is that, as previously described, is that while it is sufficient to fit a scene within the overall dynamic range, it does not allow for placement of scene elements along a contrast curve with adjustments to lighting, camera, and placement of scene elements.

Achieving accurate focus is another challenge in acquisition as the resolution of image formats exceed the resolving power of the optics on-camera monitors. This objective is further compromised by a combination of image size and viewing distance. There are two main applications of focus. These are achieving sharp focus for relatively static scenes and focus pulls to maintain sharp focus for objects in motion. Peaking is a method used in cameras today to identify sharp edges in an image. While the sensitivity to edges can be adjusted, it only displays one sensitivity adjustment at a time. What would be desirable is to provide a perceptually qualified image for different regions of focus. This means that only the regions of an image falling within a specified range of focus are shown individually or in combination. Typically, the ranges of interest are the sharpest point of focus, within the depth of field, and out of focus. For focus pulls, non-relevant parts of the image are a distraction, so only showing those parts of an image in sharp focus would be of benefit with the remainder of the image simplified significantly.

The second main category of appearance related issues have to do with carrying the appearance of an artistic look across the content creation workflow and within each of the main applications. As described below, embodiments of the invention address these deficiencies.

Carrying a Look across the workflow is based on frame identical images. Examples of carrying appearance across the workflow include carrying the appearance of a concept Look from pre-visualization to production, to enable a colorist to see the intended Look of the cinematographer, and finally carrying the appearance of the final Look to end-viewers with content that is transcoding to various distribution formats in mastering.

Carrying a Look within an application involves both frame identical images and different images. In acquisition, examples of carrying the appearance of a Look across different images include appearance-based camera balance for both multi-camera and 3D shooting or preserving the appearance of acquired images with lens or scene changes. This can also include coordinating appearance across geographically dispersed production or re-establishing a setup to recover a Look from a previous point in time. In post production, an example of carrying a Look across different images is scene matching. An example of carrying the Look across frame identical images in post production includes ensuring image appearance consistency across tens of distributed FX, color, and editing seats.

An image starts as a format acquired with a camera, then is transcoded to a format that is manipulated to instill an appearance, and finally it is transcoded to a distribution format. In each of these cases the image is represented within a finite color gamut defined by the working color space and a dynamic range with varying forms of compressive profiles applied. Successfully carrying appearance to the end-screen includes accurately mapping the image appearance across these color space and dynamic range envelopes.

Carrying a Look across the workflow is complicated by the format conversions that take place in acquisition, post production, and final mastering. These transcoding operations involve mapping content across color spaces and variations in dynamic range. As the overall workflow is device independent image appearance is not preserved with these transcodes.

FIG. 5 illustrates the variation in luminous energy encountered “scene to screen” for an example workflow. This starts with scene luminance, which is compressed to the dynamic range of a camera, typically in the dynamic range of 7 to 13 stops, 2.1 to 3.9 Log 10 respectively. It might then be transcoded to ACES, a device independent image interchange format sponsored by the American Academy of Arts and Sciences, which supports up to a 17 stop range, 5.1 Log 10, used as an intermediate color space for instilling a Look via color grading and special effects. This is then transcoded to a color space appropriate for a display device and the mode of distribution to that device. The contrast range that the best display devices are capable of producing is on the order of 10², or 2 Log 10, which also corresponds to the dynamic range at a given state of light-dark adaption of the HVS.

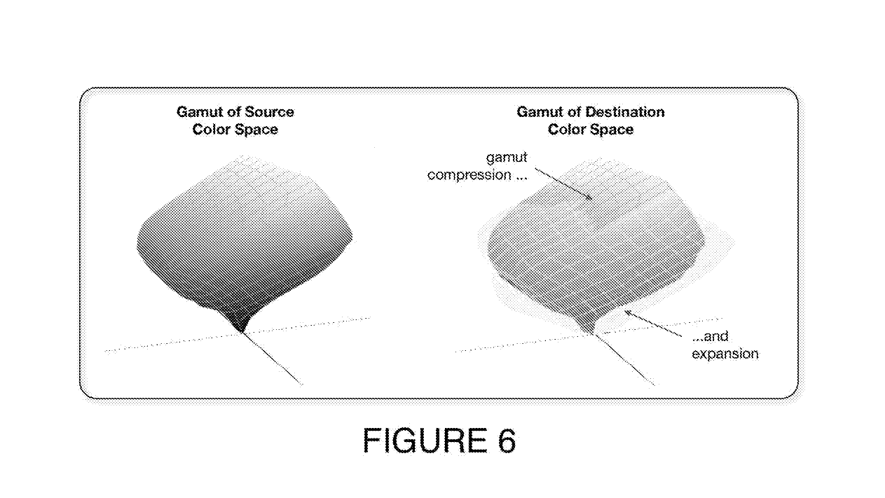

FIG. 6 illustrates a similar compression-expansion-compression of color gamut across color spaces in which transcoding would preferably carry appearance. To do so requires perceptually accurate gamut compression and expansion across different color space gamut's. Ideally, appearance attributes are carried across the workflow and to the end-viewers with multiple format transcodes involving gamut mapping and dynamic range expansion and compression, and which accounts for the for the adaptive appearance effects associated with the end-screen, projection devices, and the image itself. Present day tools that are device independent are unable to effectively model the appearance effects of these factors. An important example of the ramification of these limitations is that for high-value content a separate color grade is done specific to each end-screen. This example alone illustrates the time and expense of activities to overcome the limitations of current tools.

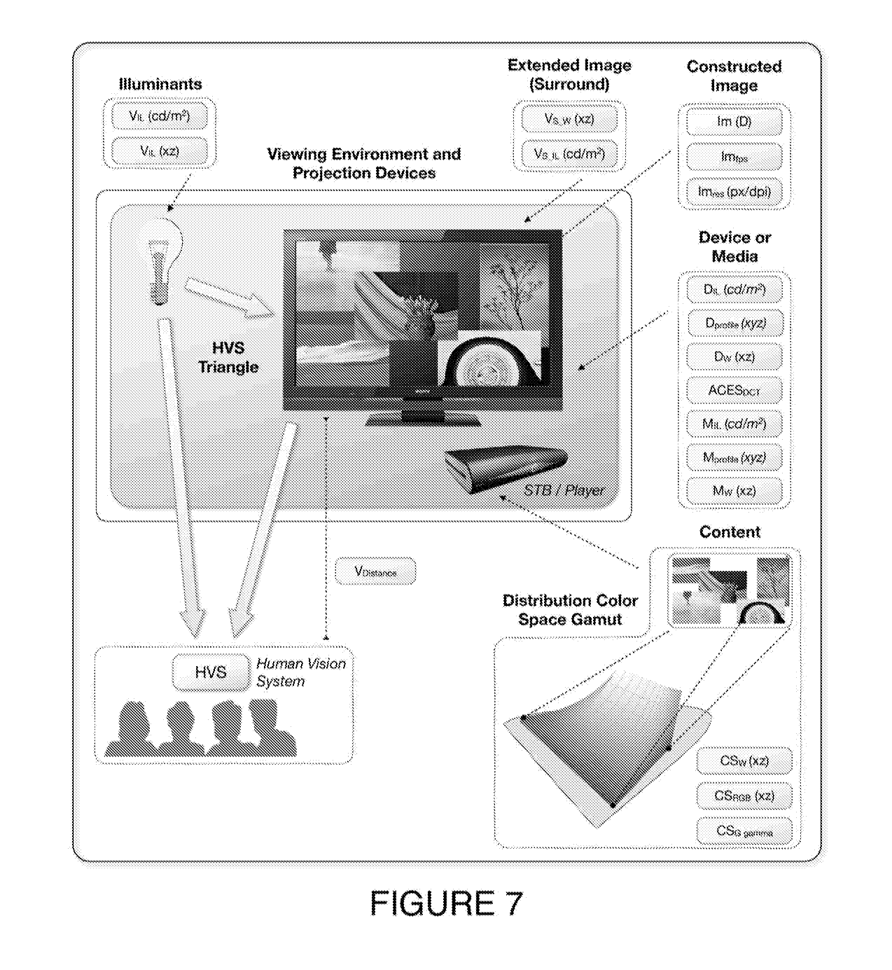

Details of the parameters of the viewing environment and the devices or printed media to which the human visual system is responding are illustrated in FIG. 7. They are shown in the context of the visual triangle referring to the fact that the HVS responds to both objects and illuminants. The parameters that drive adaptions of the HVS are represented by the oval text boxes. The visual triangle helps to describe the interaction of the viewing environment, devices, the image, and distribution color spaces.

Effects of the viewing environment include viewing geometries and image size, illuminating light sources in the viewing environment and the surround to the image. The effects of illuminating light sources to image appearance is described by the illuminants (characterization of a spectral power distribution) to objects, and the illuminants to the HVS interaction in the visual triangle. The primary adaptive response to illuminants is discounting the illuminant that provides for color constancy of objects. This occurs through the mechanism of chromatic adaption, which can be thought of as independent gain control of the three cone photo sensor types. With chromatic adaption, this allows white to appear white across differences in illuminant spectral power distributions which, in turn, drives similar appearances in color. For example, a banana looks yellow inside or outside. For chromatic adaption to occur requires both illuminated objects and an illuminating source. Light sources provide clues for visual system to “white balance,” which involves cognitive feedback to the LGN. In a dark viewing environment, the visual system lacks the clues to white balance and thus chromatic adaption does not occur, whereas viewing content on a television in a brighter environment enables the HVS to chromatically adapt to the color temperature of light sources.

Experienced colorists intuitively understand how to take advantage of chromatic adaptions. They do this by shifting the white point of the image across different scenes. For example, if a viewer sees an extended in time series of clips that have a yellow cast, which is then followed by a sudden change to a scene with a blue cast, the effect will be even more pronounced. This is because the viewer is fully adapted to the yellowish cast and it takes time to adapt to a blue cast. But colorists often work through clips out of sync with the final viewing sequence, and therefore chromatic adaption will cause them to “desynchronize” from what the viewer sees. Tools capable of more effectively modeling appearance are needed to help mitigate these effects. In a dark theatre, this effect will be more pronounced to the end-viewer due to the lack of illuminants to trigger chromatic adaption. In a brighter viewing environment for television this effect will be less pronounced.

Devices and the surround to the image are objects to the HVS. Content presented digitally is through either projection or self-projection devices with differing abilities of producible gamut, brightness and contrast. Printed media is constrained by reflective properties of that media, its effective white, and the producible gamut and dynamic range of a specific paper-ink combination. Variations in producible brightness and gamut of devices or media impact image appearance in significant ways. In particular, variations in brightness scale an image's relative color appearance attributes, colorfulness, and suprathreshold and threshold achromatic and chromatic image contrast. The mix of display white and illuminant white in the viewing environment should be accounted for to model chromatic adaption.

The surround to an image impacts appearance through both its color and average luminance. Examples of resulting appearance effects include simultaneous contrast.

The image itself impacts perceived color, image contrast, and sharpness. Factors of the image to which the HVS adapts includes its spatial structure and frequency, and, in the case of moving images, its temporal dynamics or frequency. These parameters impact perceived image suprathreshold and threshold achromatic and chromatic contrast, broadband image tonal balance and dynamic range, and color attributes.

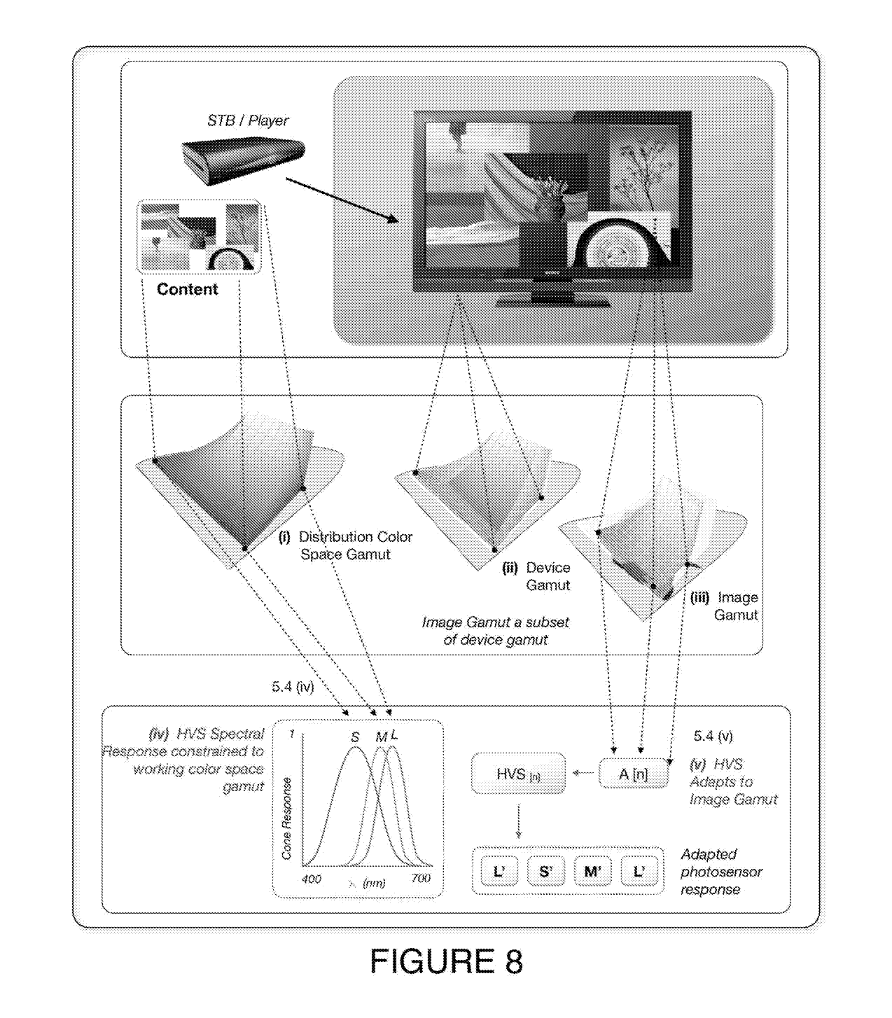

FIG. 8 provides additional detail of how gamut and color space come into play in the end-viewing environment. To illustrate these effects a simplification is made that luminance levels of viewing environment parameters are low. The distribution color space, illustrated as (i), defines the overall envelope of gamut, dynamic range, and the compressive profile of luminance that an image can realize and is what the HVS primarily adapts to. The gamut and dynamic range of a given device or printed media, illustrated as (ii), is a subset of the distribution color space gamut and the actual image gamut, illustrated as (iii), to which the HVS adapts moment to moment, ranges across a subset of the device's capabilities. For the purposes of appearance modeling it is helpful to think in terms of the HVS having an overall response, illustrated as (iv), which is gated by the distribution color space while adapting to the composition of the image, illustrated as (v), at any given point in time. The effects of viewing environment parameters are additive to these effects.

Finally, another temporal aspect is the time it takes for the HVS to adapt to all of these factors. The adaptive response of the HVS to all of these parameters and effects is based on a complex non-linear interaction of these parameters. This in turn drives significant differences of image appearance for end-viewers viewing content across a multiplicity of viewing environments and devices or media which are not currently modeled with today's tools.

Viewing environment issues are not only a concern for end-viewers. Artists view content in different and often uncontrolled viewing environments and displays, which creates the same issues as described above. For example, a cinematographer whose eyes are adapted to the illumination of a scene being shot outside may go to an inside location to view how the scene looks on a reference monitor. Unless the cinematographer waits until his or her eyes adjust to the conditions inside versus outside, which can take on the order of minutes, the appearance of what the cinematographer sees will not be accurate within the limitations of device independent tools. This is due to chromatic and light-dark adaptions to the different viewing conditions as described above.

Another example of an appearance related issue for artists is for a colorist who exploits the appearance effects of chromatic adaption as previously described as it relates to the Look over the arc of a film. The issue is that a colorist generally works with clips out of sync of the final viewing sequence, and thus chromatic adaption plays out differently for them versus the end-viewer. To compensate, a colorist will frequently try to recalibrate their state of chromatic adaption by looking at a neutral grey card under D65 illumination. This is still problematic because neutral grey is unlikely to be what just preceded the clip the colorist was working on. Tools capable of more effectively modeling appearance are needed to help mitigate these effects especially with various forms of carrying a Look across clips.

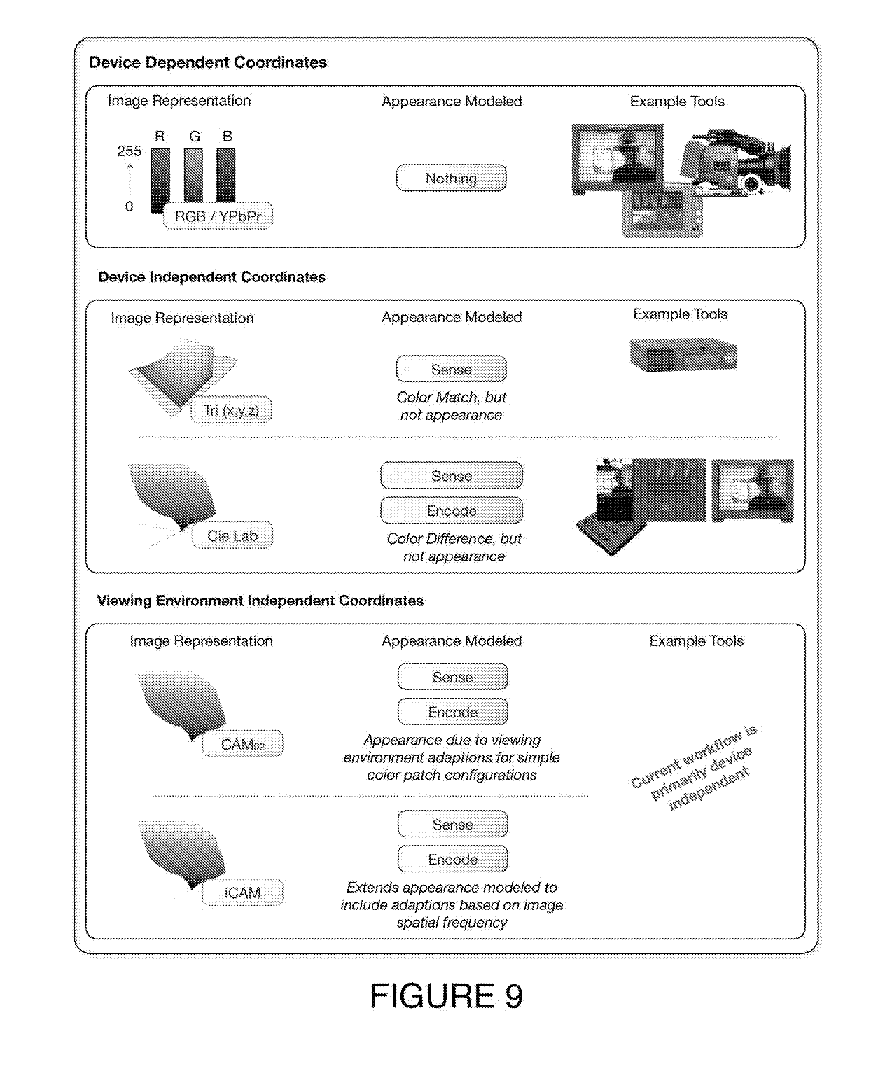

To understand the handicaps imposed on tools used in content creation first requires a look at the categories of image representation models used within those tools. These image representation models are device coordinates, device independent coordinates, and viewing environment independent coordinates. FIG. 9 illustrates each of these categories, what they can and cannot model in terms of image appearance, and examples of devices that use a given image representation category.

Device coordinates are image coordinate systems that are designed to drive a viewing device and are used in cameras. They have no ability to predict appearance, because not only do they not model the non-linear adaptions of the HVS, but also they have no relation to perceptual coordinates of any kind. For example, an RGB image representation provides R, G, and B values for each pixel. These R, G, and B representations are independent and are on a linear scale from black to white. In acquisition, images are often represented in YPbPr coordinates where Y is luma with a compressive power law applied to it and Pb and Pr are color difference coordinates, which may or may not be compressed. For HD television the power law exponent is 2.2, which is the inverse of the power law response of cathode ray tubes, to provide a net system gamma of one. In YPbPr there is at least a similarity to HVS processing of light energy in that they are both compressive. From an appearance modeling perspective, the term device coordinates refers to the fact that the image representation model is not decoupled from the device. For example, if one were to hold the image and viewing environment constant, a given image would look quite differently when viewed on different monitors. This is because each monitor will have a different physical rendering of RGB to light. There is no bridge of the RGB coordinates to perceptual coordinated thus it cannot carry image appearance across devices with different physical renderings of RGB to light.

Content is acquired and viewed on devices and thus a transformation from device coordinates to image representation models that are perceptual is a starting point for the objective of carrying appearance across devices. Device independent coordinates systems are able to decouple the image from the device. For example, for two monitors that have the same capabilities of producible gamut and dynamic range, are of the same size, and are viewed next to each other in the same viewing environment, a device independent image representation accounts for differences in how the two monitors render light and thus how an image would appear the same on both monitors.

This is performed through a two-step process in which a device is first calibrated and then characterized. A device is first calibrated to a working color space, which adjusts the gain of the device such that white and the highest chrominance red, blue, and green primaries correspond to the specified values for a given color space expressed in tristimulus (Yxz) coordinates. For example, if the device is a camera with one sensor dedicated to each RGB channel, the gain of each channel will be adjusted to correspond to the color space white point and color primaries when the frame is set to a white camera-calibration chart. This is accomplished with a waveform monitor and an external calibration chart placed in a scene. If the working color space is the well-known rec. 709, the gain of a camera's red, green, and blue channels can be adjusted so that a white card will read the net spectral power distribution falling on the card as corresponding to D65, i.e. white for the rec. 709 color space. In a similar fashion a waveform monitor and external calibration chart is used to adjust the gain of the camera's sensors such that the red, green, and blue color primaries are consistent with the rec. 709 gamut, and ensure that the applied compressive profile corresponds to 2.2.

Once a device is calibrated, it is then characterized, which provides a mapping of the devices physical rendering of light in response to known colors to Tristimulus (Yxz) values. For example, in the case of a monitor, a colorimeter measures sequentially applied color patches with known Tristimulus (Yxz) values against the monitors rendering of that color to build this mapping. Tri-stimulus is a color matching color space which can predict when two color will look the same under identical viewing conditions. It is the bridge from device coordinates to perceptual coordinates in that all appearance models start from a pre-adapted tristimulus (Yxz) image representation. In content creation reference monitors are calibrated and characterized and cameras are only calibrated. If an image is not modified, a Tristimulus image representation allows for the device independent scenario described above.

Images are almost universally modified to instill a particular Look, and merely using a color matching space is not sufficient to enable modifications to an image. Instead, making such modifications uses a perceptually linear color difference space, which is approximately provided by CIE Lab. CIE Lab provides a three-dimensional color difference space defined by the relative color appearance attributes of lightness, hue, and chroma. The goal, achieved to some degree, was to construct a perceptually linear color space. That is, as a given Euclidian line segment was moved through this space, changes in the perceptual differences along these three image attributes would be perceived as perceptually linear. A linear color difference model enables a linear combination of matrix transformations to adjust an image. For example, this allows PHOTOSHOP to construct its layered image adjustment paradigm. Each layer comprises linear operations to pixels that in turn can be combined to produce a final image result.

One drawback is that CIE Lab is not capable of modeling adaptive appearance effects. Its chromatic adaption transform was normalized to a fixed viewing environment of D65 with a white to middle grey surround. The authors of CIE Lab were keenly aware of these limitations which are why they positioned it as a color difference model as opposed to an appearance model. CIE Lab or variations of CIE Lab are the basis of all tools currently in-use, examples of which include color grading systems, color space transcoders, and Look Luts, etc. The inability of CIE Lab to model adaptive appearance effects is the key issue which underlies all of the challenges described associated with creating an artistic Look and carrying it to end-viewers across multiple end-screens and devices or printed media.

CIEAM97 and CIECAM02 are viewing environment independent image representation models. They are capable of modeling some of the adaptions associated with variations in viewing environment and brightness. But these models were developed and tested with psycho-physic test sets for simple color patches as both the image and the surround and have no mechanism to model adaptive effects of image structure and dynamics. Thus, it is not capable of carrying appearance in which adaptions are triggered by the composition of the image itself.

iCAM is an image appearance model developed by Mark Fairchild and Garrett Johnson that was published in 2002 at the IS&T/SID 10th Color Imaging Conference. iCAM does take into account adaptions associated with image spatial frequency and one of its targeted benefits is to map high dynamic range images to a lower dynamic range capable of being displayed by devices. But, it does not include temporal image frequency and is thus is limited to still images. Other adaptive appearance effects not modeled by iCAM include viewing geometries and image size which impacts perceived tonal and chromatic contrast, sharpness, and color effects such as spreading. These appearance effects are highly relevant in today's environment where the same content might be viewed in a cinema or on a smart phone.

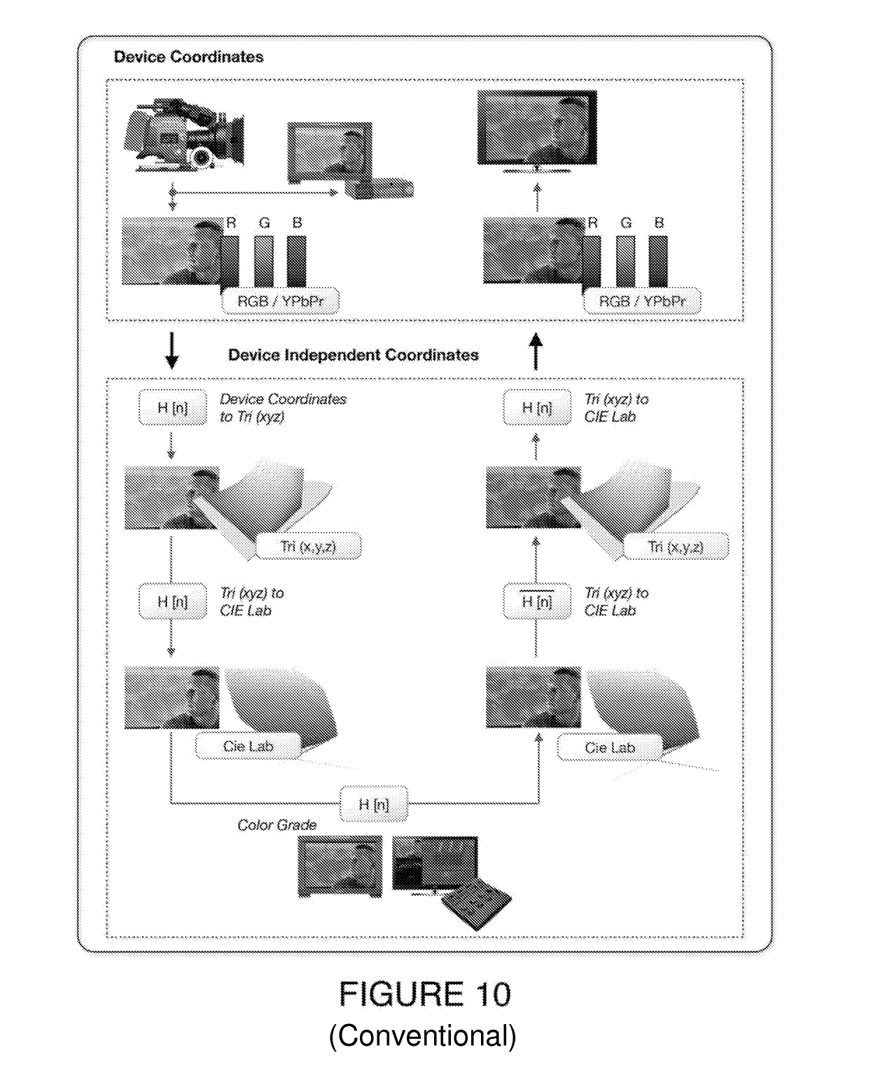

FIG. 10 illustrates a representative device independent color workflow in use today. This, likewise, does not provide viewing environment independence. In fact, to provide a complete solution to managing image appearance from scene to screen it is desirable to achieve moving image, color space, and dynamic range independence in addition to viewing environment independence.

In the example illustrated in FIG. 10, a camera is calibrated to a working color space and compressive profile. There are no present tools that can characterize a camera in the field, which limits the degree to which cameras can be balanced to capture a scene as identically as possible. A color space convertor such as a Davio box by Cine-tal of Indianapolis, Ind., is used to map the acquisition format to a format adjusted to the color space, power law compression, and characterization of the reference monitor. But, because it operates on a device independent image representation, it essentially carries colorimetry versus appearance from the acquisition device to the reference monitor. This is an important step because the reference monitor is the visual bible on set in relation to artistic Look.

An example color workflow with reference to FIG. 10 might include the following processes. An image is first converted from device coordinates to Tristimulus (Yxz). Ideally the device is both calibrated and characterized to the operating color space and gamma. It is then converted to CIE Lab, which is the working image representation model in a color grading or FX system. At that point an image is modified to instill the desired appearance or look. Then, to enable the image to be viewed on a different display device and color space, the modified image goes through an inverse CIE Lab to Tristimulus (Yxz) transformation, and is then converted to the appropriate device coordinates for the display with the assistance of a profile describing the mapping from Tristimulus (Yxz) to that particular device. All of the limitations described of a device independent image representation model impede carrying the appearance of an image as it was acquired or shaped and viewed on a monitor, to a display at another point in content creation or the final presentation display to the end-viewer.

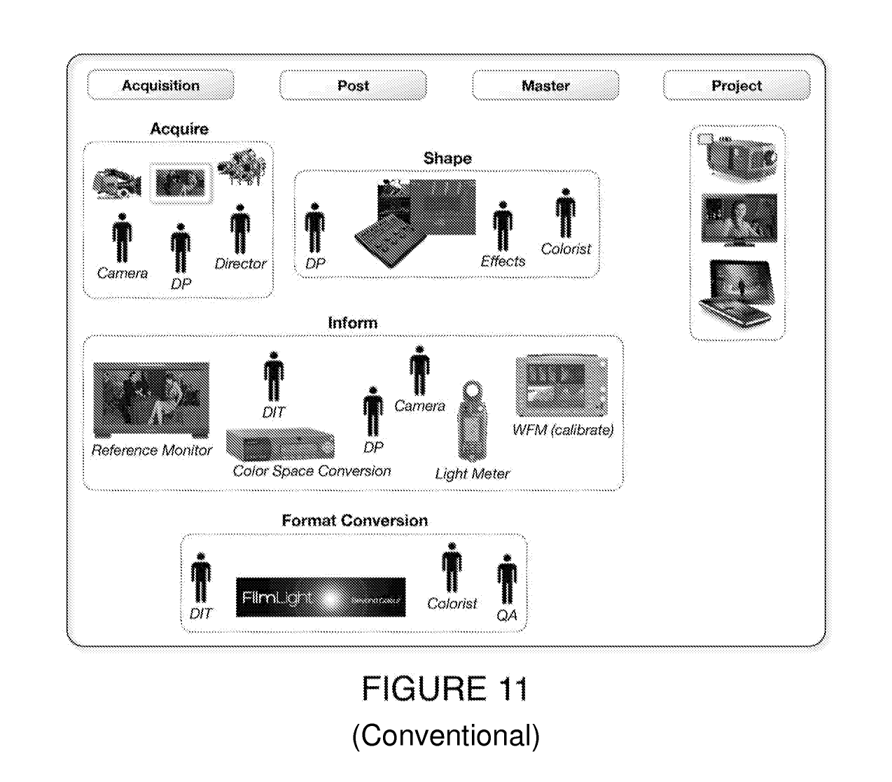

FIG. 11 shows the categories of conventional tools across the content creation workflow specific to moving images. These categories are: acquire content, shape content, inform adjustments to acquisition and shaping tools, format conversion, and projection devices.

First, cameras are used to acquire images. While cameras tend to push the technology envelope in the industry with faster frame-rates, higher resolution formats such as 4K, and increasing dynamic range, they are “dumb” instruments when it comes to interpreting scene lighting. They require an external waveform monitor to ensure proper calibration to a working color space and compressive profile for a given lighting set-up for a scene. Waveform monitors enable camera calibration but, because they are device-coordinates based systems, they cannot inform adjustments to cameras or lighting based on appearance or even to the perceptual degree enabled by CIE Lab.

Information tools inform adjustments to lighting and camera in acquisition, and to color and effects tools, which shape content. Information tools may be based on device, or device independent image representation models. Their ability to inform changes to devices or content is limited to these respective image representation models. Information tools include:

Waveform monitors (WFMs), which are used to calibrate cameras and content to an acquisition, grading, or distribution color space. WFMs are device-coordinates based instruments, and as such they inform conformance to a color space gamut and white point, and can assist in setting image gamma. But they do not inform appearance. Another issue with WFMs is how image information is presented to artists and technical image specialists, which tends to abstract color and luma.

Real-time color space transformations to convert a camera's color space to a reference monitor color space for critical viewing perform transcoding on a device independent image representation and thus carries limitations as described in relation to appearance.

Color decision lists and View LUTs might be used to communicate a Look across different points in the workflow as in the example of conveying the cinematographers' intention of a Look to be used as a starting point for the colorist. These are also device-independent based tools and thus fall short in carrying appearance.

As noted, it is becoming increasingly difficult to achieve critical focus and accurate focus pulls with high resolution 2 k and 4 k formats. These formats exceed the resolving power of on-camera monitor optics complicated by perceptual issues associated with the monitor's screen size and viewing distance.

Tools that shape or modify content are device-independent based systems that include color correction and special effects software to instill a desired appearance in content.

Format transcoding converts content from one color space and gamma to another. For example, FIG. 5 showed that content might be acquired in Arri's Log C, converted and graded in ACES, and then converted to various distribution mastering formats including DCI for digital cinema, rec. 709 for HD TV (from International Telecommunication Union Sector-R), and ProRes HQ (a lossy video compression format developed by Apple, Inc.) also in rec. 709 for internet on-demand delivery. Transcoding algorithms are based on device independent image representation models.

End-viewing displays may include digital cinema projection systems, television, and mobile smart phones and tablets. Content in a mastering process is adjusted to be compliant for a given distribution and device color space and gamma. Digital cinema is well characterized and reasonably maintained by theatre operators. This allows a Look to be carried within the limitations of a device independent color workflow. On the other hand, the situation for television and mobile viewing devices is less well characterized and controlled. TVs are generally not properly calibrated, viewing environments vary significantly, and television manufacturers make image “enhancement” processing and brightness. Mobile devices can be viewed in any environment from inside to outside. These factors mean that carrying a Look falls short of the degree to which it can be carried with a device independent color workflow.

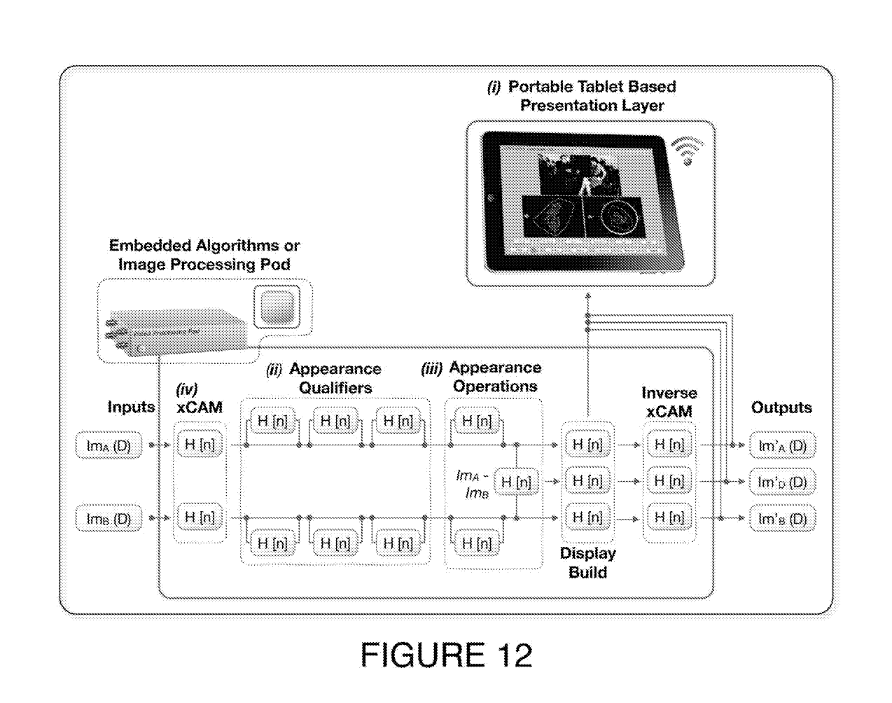

FIG. 12 illustrates a simplified overview of an Image Appearance Framework according to embodiments of the invention. This framework enables applications that facilitate the creation of an appearance or Look in still and moving images and carries the appearance of that Look to end-viewers more effectively and efficiently in comparison to existing tools and methods. Individual modules of the Image Appearance Framework (IAF) can be configured to address numerous applications across the content creation and display workflow for both moving and printed images.

An overview and the modules and unique capabilities of the IAF are briefly summarized below followed by an overview of applications addressable with the IAF. Next, an Image Appearance Monitor “TAM” and its application is described in detail which is one of the applications of the TAF. This provides a detailed description of the functionality of the modules of the TAF and how they perform as a system allowing for the other applications of the TAF to be more efficiently described.

Overview

The TAF framework is designed to process two images in real or deferred time as appropriate for a given application. Supporting two image processing pipelines is preferable. For example, the ability to perform an image appearance difference operation of two images is helpful to carrying the appearance of an image across the workflow or within an application as previously described. One or both images are converted from device to image appearance coordinates in xCAM. This enables one or more image appearance-based qualifiers to be applied to isolate image attributes of interest that are perceptually accurate. Subsequent to the application of image qualifiers, which may or may not have been applied, image appearance-based operations can be applied involving one or both images. The operations may include, for example, an image appearance difference operation of image A, ImA, and image B, ImB. Or ImA−ImB=ImD. Three new data presentation formats, or displays, which are introduced as part of the presentation layer, present the results of any applied qualifications or operations involving either ImA, ImB, or ImD. For some of the applications of an IAF including an TAM, Images ImA and ImB may be converted to device coordinates that are adjusted to appear correct from an appearance perspective on a display device in a given viewing environment.

Modules of the TAF include:

Image Appearance Model, xCAM, which is illustrated as (iv) in FIG. 12. xCAM predicts all of the appearance effects of HVS adaptions triggered in creating and displaying content described in the HVS adaption triggers section.

This capability enables moving images, viewing geometry and image size, color space, brightness, and dynamic range independence in addition to device and viewing environment independence provided by other models.

Outputs of xCAM include chromatic, and achromatic suprathreshold and threshold contrast signatures in addition to absolute and relative color appearance attributes. This capability, in conjunction with the image appearance qualifications and operations, and the presentation layer of the IAF, informs adjustments to camera and lighting or content, or directly modifies content to more effectively carry still and moving image appearance across color space transformations, viewing environments, devices and media. This provides a more complete solution to manage image appearance from “scene to screen”.

xCAM is able to model the non-linear adaptive response of the HVS at the computational performance of digital signal processing techniques for shift invariant linear systems. This provides both higher efficacy in modeling appearance and enables a model that can scale from deferred time to real-time image appearance processing.

Appearance-Based Image Qualifiers, which is illustrated as (ii) of FIG. 12. These qualifications are useful to isolate specific image attributes of interest for secondary image adjustments or modification. Qualifiers can be applied to one image or independently applied to two images. An image can be qualified by region of interest, different ranges of perceived sharpness, absolute and relative color appearance attributes, achromatic suprathreshold contrast in P-stops (perceived doubling of light) or EV (f-stops), and chromatic contrast.

Appearance-Based Image Operations, which is illustrated as (iii) in FIG. 12. Operations include:

Image appearance transcoding that carries an appearance as closely as possible across color spaces, differences in brightness and dynamic range from a source viewing environment and device to a destination viewing environment and device or media.

The ability to measure an appearance difference between two frame identical or different images. For example, for an IAM, which is one of the applications of the IAF, this capability in conjunction with the new displays can inform image adjustments to achieve an appearance match as closely as possible to carry image appearance across and within the content creation workflow.

The ability to emulate the appearance of an image as it would appear in a different viewing environment and as displayed or printed on specified devices or media. This emulation can be displayed as accurately as possible to a local calibrated and characterized display monitor and can also be used for image appearance difference operations. It also provides the basis of modifying content to carry its appearance to a specified viewing environment and device.

An operation useful for an IAM is the ability to provide a scene specific characterization of a camera in conjunction with an external calibration chart. This better enables appearance-based camera balance including focus for multi-camera or 3D shooting, and better optimization of compression of luminance for a given dynamic range of a camera, scene elements of interest, desired Look, and the end-viewing environment.

Presentation Layer—illustrated as (i) of FIG. 12.

For applications involving an interaction with artists and technical users, a presentation layer is described that intuitively, effectively, and efficiently informs adjustments to camera and lighting, or content based on appearance.

The presentation layer provides three new synchronized displays, which provide image appearance information in both an image-centric manner and light and color views to inform adjustments to gain and color in cameras, lighting, and color and special effects software.

The presentation layer also provides a unique interaction design that supports both the artists “flow”, and the need to accomplish tasks under considerable time pressure.

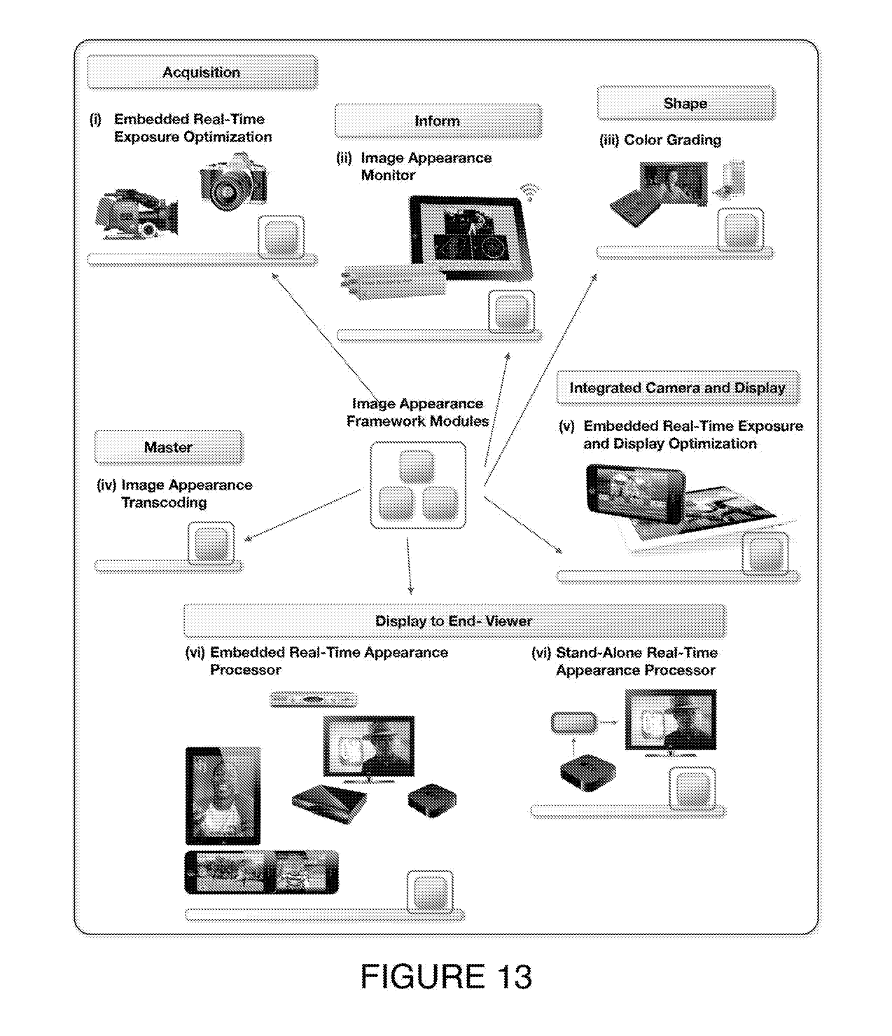

The IAF provides the flexibility to address several applications that benefit from a more robust image appearance model, and image operations, qualifications and presentation layer which are enabled by this model as illustrated in FIG. 13. An overview of these applications is described below. Then, the IAM will be described in detail followed by a more detailed description of the other applications of the IAF.

Applications of the IAF include:

Embedded Real-Time exposure optimization, which is illustrated as (i) of FIG. 13, which provides the ability to optimize the compressive contrast profile specific to a scene utilizing appearance technology, which can be applied pre or post sensor in real-time. In some embodiments this optimization is resident on the image acquisition device, such as cameras, etc.

Image Appearance Monitor “IAM”, which is illustrated as (ii) of FIG. 13, informs adjustments to camera or content based on appearance.

Color Grading—illustrated as (iii) of FIG. 13, providing a display and functional paradigm that more intuitive enables primary and secondary corrections to content, informs image matching based on appearance, and provides an appearance-based soft proof of the printed media or digital signage display as it would appear in a specified viewing environment.

Appearance Based Transcoding, which is illustrated as (iv) of FIG. 13. This type of transcoding more effectively carries image appearance as closely as possible across different color spaces, and differing levels of image brightness, dynamic range and applied gammas, which incorporates the appearance effects of end-viewing environment and devices and their interaction with the image itself. This form of transcoding has many applications including enabling “grade once, transcode many” in mastering, real-time format and color space transformations used to drive reference monitors, and real-time point of display image appearance processing to adjust an image appropriate to device characteristics and the viewing environment.

Real-Time Image Appearance Processing at the point of display provided as embedded algorithms, which is illustrated as (vi) of FIG. 13. These embedded algorithms could be licensed to and possibly contained in Set Top Boxes (STBs), DVD players, or are licensed to television manufacturers and included in televisions themselves. Embedded algorithms may also be licensed to integrated microprocessor/graphic chips, or stand-alone graphic card manufacturers. These integrated processors or processes enable appearance-based processing integrated in a general computer OS or embedded OS in a stand-alone graphics card. These embedded algorithms provide the ability to modify content in real-time enabling its appearance to be seen as closely as possible to the intended artistic Look. This capability is enhanced if the device provides the ability to characterize the display device and viewing environment.

Real-Time Image Appearance Processing at the point of display in a stand-alone device which would sit between a content delivery mechanism such as a STB and a display device such as a television. This device would first be capable of characterizing a display device and viewing environment and then incorporate those characterizations to modify content in real-time to enable its appearance to be seen as closely as possible to the intended artistic Look.

Integrated Camera and Display Devices, Embedded algorithms providing real and or deferred-time exposure and display appearance processing as described above may be resident in Smart Phones and Tablets or provided as stand-alone applications for operation on devices. The camera in these devices may be incorporated to provide a means to characterize the viewing environment.

Details of the Image Appearance Monitor are now described. An IAM is capable of informing adjustments to camera, lighting, and content based on appearance. An IAM also includes the main functionality of a waveform monitor “WFM” which is to calibrate cameras to an acquisition color space and standard gamma, and to ensure compliance of content in color grading and mastering to the grading and distribution color space and gammas respectively.

Applications of the IAM include:

Across the Content Creation Workflow:
Informing adjustments to achieve an image appearance match for the same image as it moves from acquisition to post to mastering.
Providing the ability to emulate an image at a different points in the workflow. For example a camera's exposure and gamma can be optimized against a view of how it would look in digital cinema. In a similar fashion, a color grader could grade content based on what it would look like on a specified end-screen or a specific media-ink combination in a specified viewing environment such as a home, gallery, or museum, etc.
Providing more intuitive displays for artistic and technical users that provide a clear linkage between presented appearance information and image elements, and also provides an at-a-glance view of the distribution of color from black to white. These displays which provide different views of adapted appearance enables faster and more effective camera set-up and scene matching in color grading, and managing image consistency across the workflow.
Providing more accurate color space transforms applied to a reference monitor that incorporates appearance effects of viewing environment and the image itself. For example, a cinematographer is able to see as accurately as possible what is being acquired by camera.
Acquisition
The ability to characterize the color and compressive response of a camera specific to a scene at a specific gain and exposure setting. These scene-specific camera characterizations can be utilized in conjunction with other functional capabilities of the IAM to enable more effective and efficient camera set-up, exposure, balancing and focus in support of a desired Look.
Appearance-based camera balance and the ability to more accurately match a previously established appearance with changes to camera, lighting, lens used, etc. For example, multiple cameras could be set to capture the appearance attributes of skin as closely as possible.
Improved focus for still and moving shots by providing a perceptual indication of elements of an image that are resolved at the sharpest point of focus, that are within the depth-of-field, and that are out-of focus.

Post production and Mastering
Informing adjustments in color grading to carry an appearance as loosely or tightly as desired across clips for scene matching and the film as a whole.
Facilitating matching color to acquired camera footage in FX for workflows that are sequenced as FX-Edit-Color.
Managing appearance consistency more effectively across multiple FX seats shaping content in parallel.

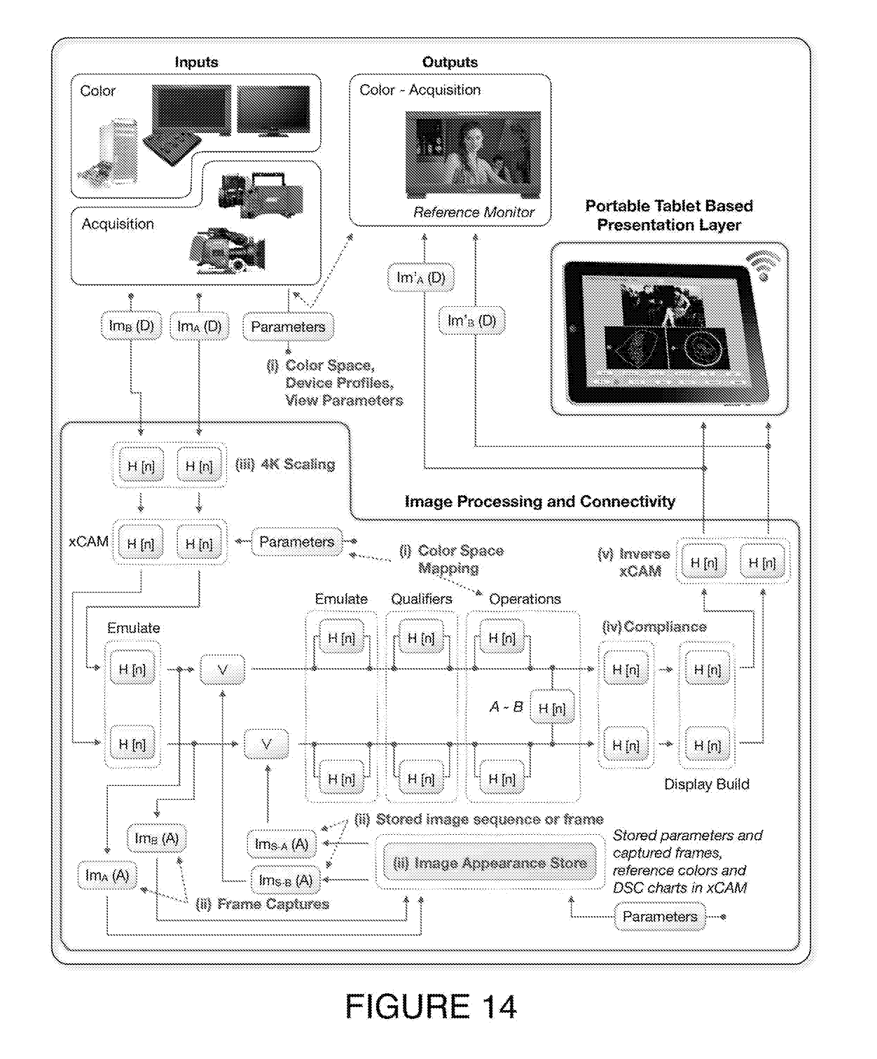

FIG. 14 is an example Image Appearance Monitor that may include and utilize any or all of the IAF modules described above, and further contains additional functional components as illustrated in FIG. 14.

The Image Appearance Architecture of FIG. 14 includes:

Physical connectivity to external devices.

Incorporation of monitor device profiles and viewing environment parameters, illustrated as (i) of FIG. 14, which are used in making a device to xCAM transform, as well as the inverse xCAM to a destination device/viewing environment transform.

Incorporation of color space, device and viewing environment parameters.

Storage, illustrated as (ii) of FIG. 14, for acquired images and pre-loaded or constructed calibration images in xCAM image appearance coordinates, and color space, device and viewing environment parameters.

Compatibility with the ACES interchange format including the ACES color space, input and output device characterizations transforms (IDT and ODT, respectively), and the Reference Rendering Transform (RRT), which serves as the intermediary between the ACES color space and ODTs to various devices.

Pre-conditioning high bandwidth content, such as up to 4K content or higher as the industry continues to progress, illustrated as (iii) of FIG. 14, provides for more efficient device to image appearance transforms for real-time performance.

Compliance, illustrated as (iv) of FIG. 14, provides the core functionality of a WFM, to calibrate cameras to an acquisition color space and ensure compliance of content to a grading or distribution color space.

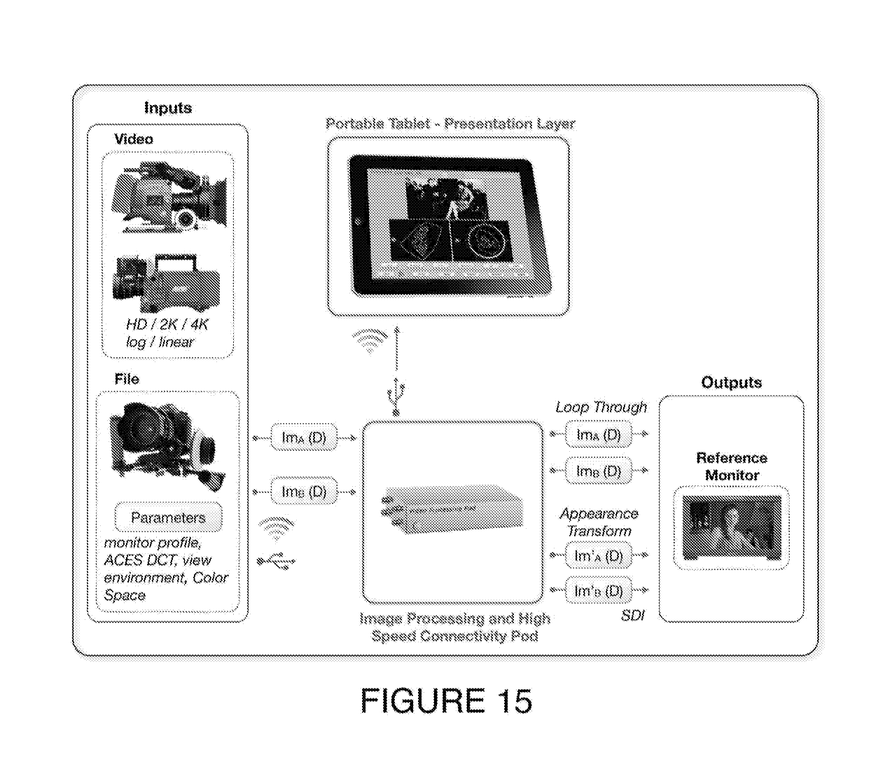

FIG. 15 illustrates an example physical implementation of an IAM. This example includes an Image processing Pod and a tablet containing a User Interface (UI), which has either a wireless or physical connection to the image processing Pod. Separating the UI from the processing Pod provides the flexibility to support both semi-fixed applications on-camera or in video village, post production and mastering, and portable applications in acquisition. For example, the director could position actors at the place that they are located while viewing the image from a selected camera, or a cinematographer could see the effects of adjustments to lights at the position of the lights through the displays on the tablet.

This modular physical configuration, in combination with image appearance functional capabilities and the presentation layer, provides the flexibility to address applications from pre-visualization to mastering with one platform.

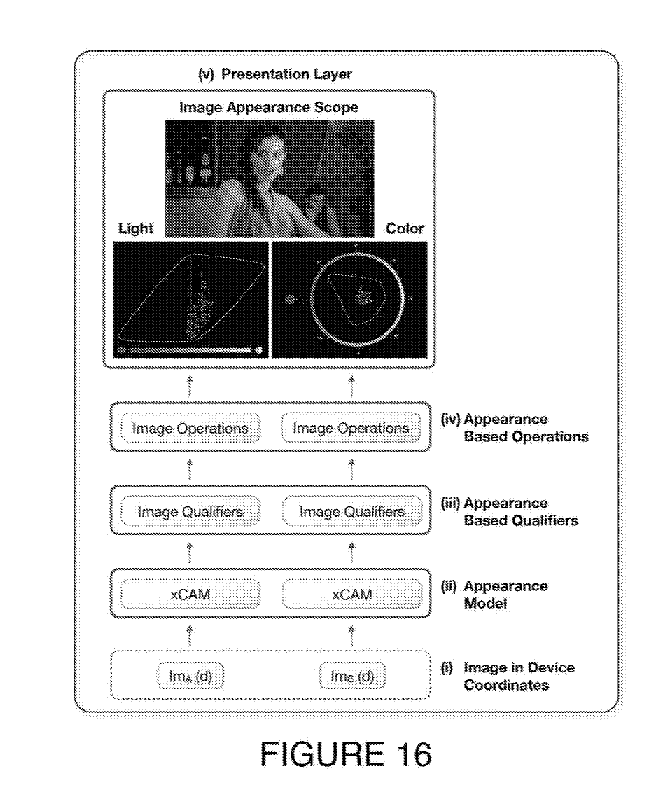

FIG. 16 illustrates the hierarchal relationship between the presentation layer, the image appearance operations and qualifications, and the image appearance model. The IAM is capable of processing two image streams in parallel. The image to be adjusted to match the appearance of the reference image might be from a second camera, a clip in scene matching applications, or an emulation of how the reference image might look at a different point in the workflow or at the end-screen. The basic flow is to first convert one or two images from device coordinates to the image appearance coordinates of xCAM. Image appearance-based qualifiers may or may not be applied to one or both of the images to isolate specific image attributes of interest. Then, image appearance-based operations can be applied to images which may or may not have been qualified. An example is an image appearance difference operation of a reference image minus an image to match to the reference. Finally, a presentation layer informs actions of artists and image specialists through three new appearance-based displays. These displays provide a direct linkage of presented image information to the image itself and also inform needed adjustments to image gain, color, and sharpness as appropriate for a given application.

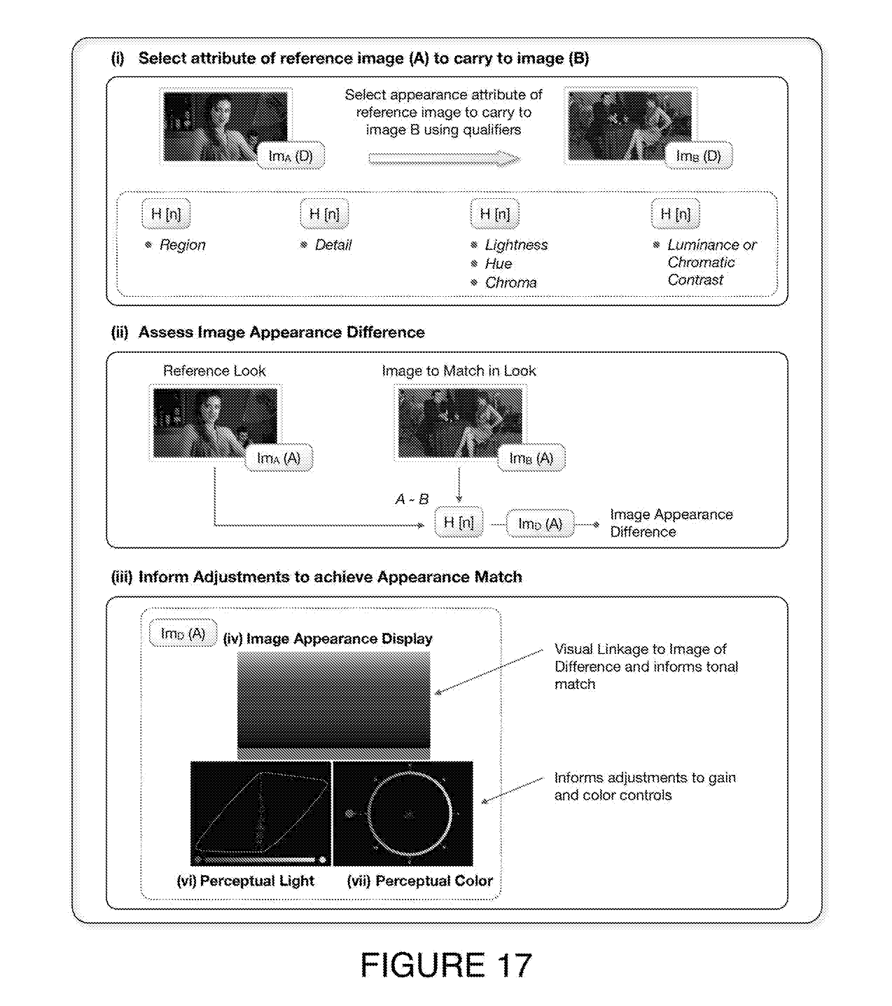

FIG. 17 illustrates an example of a functional interrelationship of the presentation layer and image appearance qualifiers and operations specific to informing scene matching in color grading. The notation used throughout this disclosure and seen in FIG. 17 is that an image in device coordinates is labeled as “ImA (D) or ImB (A),” with the suffix A and B representing an image processed in the A and B image processing channels respectively, and (D) and (A) denotes device coordinates and appearance coordinates respectively. An image that has either been qualified or to which an operation has been applied is denoted “ImA′ (A) or ImB′ (A)” where the apostrophe (′) denotes a modification in the form of either applied qualifiers or operations. The image difference of images A and B is denoted as ImD′ (D).

In a first step, a Look has been set for a reference image, ImA (A), as illustrated at (i). In this example, the operator desires to carry the appearance of one or more image attributes of ImA (A) to another image, ImB (A). A colorist could select an image attribute of interest in ImA (A) with one or more qualifiers that he or she wishes to carry to ImB (A). The qualifiers provide the flexibility to carry the appearance as closely or as loosely as desired across all image attributes impacting Look. In this example it is desired to achieve a match of the tonal balance of the two images, which can be done directly with the image contrast mode of the image appearance display without any applied image qualifications.

Next, an image appearance difference operation is made of ImA (A)−ImB (A)=ImD (A), as illustrated at (ii).

Then, as illustrated as (iii), the displays of the presentation layer present the appearance difference information, ImD (A), which as described above is the appearance difference between ImA (A) and ImB (A). In other words, ImD (A)=ImA (A)−ImB (A). The image appearance display set to the image contrast mode provides a visual indication of the differences of tonal distribution of the two images. The Light (vi) and Color (vii) displays also show the image appearance difference of the two images within a three dimensional space of lightness, hue, and chroma. The combination of these three displays quickly informs adjustments to the gain in ImB (A) in the darks, mid-tones, and brighter image areas to achieve a tonal appearance match to that of ImA (A).

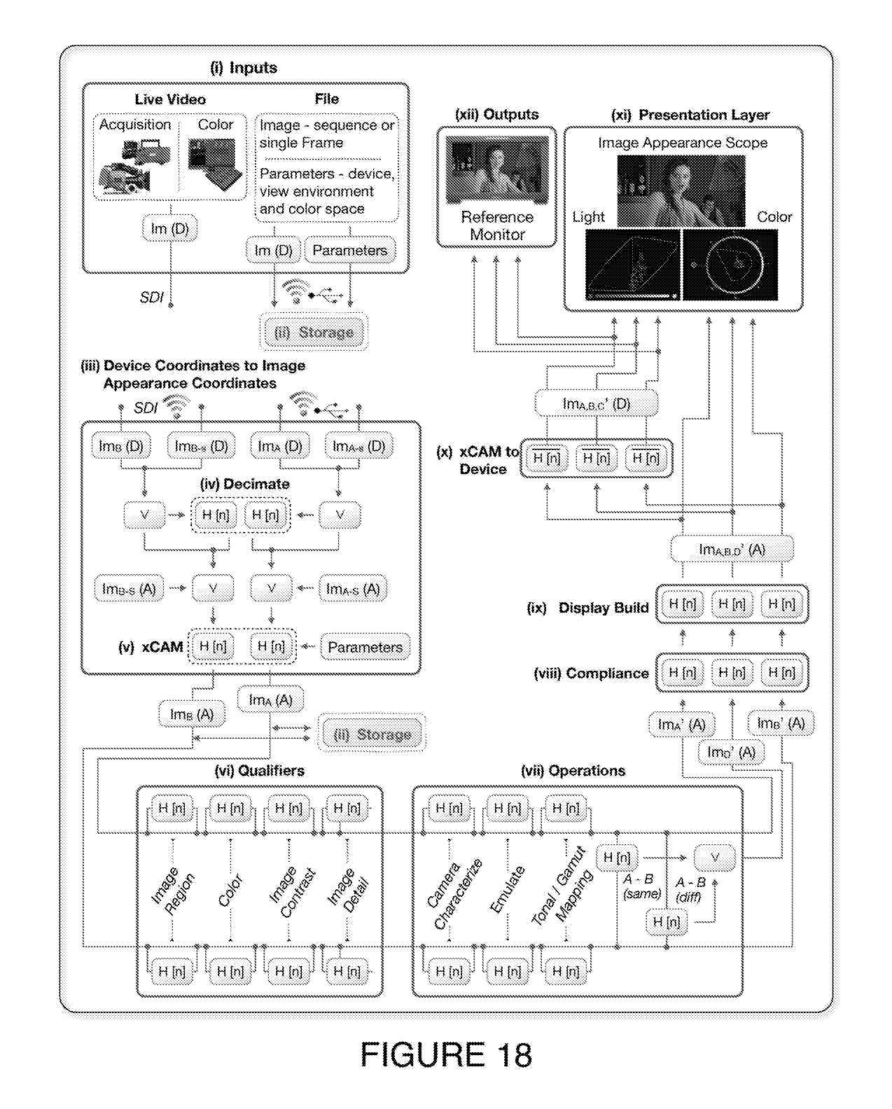

FIG. 18 illustrates the main image appearance processing flow and architecture according to embodiments of the invention.

In working with two images, embodiments of the invention allow for processing two image sequences in real-time, for example, assessing the camera balance of two cameras over the course of shooting a scene. Embodiments also allow real-time and deferred-time processing. This capability is provided by xCAM, which scales in terms of HVS adaptions modeled, and are described in more detail below.

Embodiments also allow for assessing an image sequence against a captured single frame-capture, stored calibration chart or color palette that has been processed to an xCAM representation model. An example is evaluating a scene that is being shot against a reference color palette created by the artistic director. In a specific example, the artistic director of the film True Grit by the Coen brothers stipulated an allowable range of colors on-set, which is what gave the film a natural sepia look.

Embodiments may also process two single-frame images that can be a mix of a captured frame, stored calibration chart or color palette that has been processed to an xCAM representation model. An example is a colorist who sets a reference appearance for a clip and desires to carry that appearance to another clip. Typically this is done by picking a reference frame from the first clip and a working frame from the second clip.

Even though embodiments of the invention are capable of operating on two image sequences simultaneously, the system also supports single image operations such as storing into memory single frames of video that have been previously transformed into an image appearance operation to be used as reference images for various applications.

Image inputs may be either in the form of video sequences or single image frame. Live video may be captured, for example, by Serial Digital Interface (SDI) and, for deferred time applications, images can be acquired through various communication interfaces such as Universal Serial Bus (USB) or one of the wireless data transfer mechanisms. Viewing environment, device, and color space profile parameters may be captured wirelessly or through USB as files in their respective formats. Device characterizations can be in the form of International Color Consortium (ICC) files or ACES IDTs and ODTs.

Images and parameters are stored for use as appropriate within the image processing pipeline. These images and parameters may include:

Acquired image or images that have been transformed to image appearance coordinates as either an image sequence or a single frame in image appearance coordinates.

Input parameters as described above.

Pre-loaded and user definable device, viewing environment and color space specifications.

Pre-loaded calibration images in image appearance coordinates that match physical calibration charts such as those used by a Digital Still Cameras (DSCs) used for on-set camera calibration and characterization.

User definable reference images in image appearance coordinates useful in both production and post-production. For example, a colorist could define skin tones specific to a desired appearance.

Device coordinates to image appearance coordinates are illustrated as (iii) in FIG. 18. Acquired images in device coordinates are transformed to image appearance coordinates using xCAM. For real-time applications that may include voluminous data, such as high resolution 2K and 4K image sequences, the image sequences are decimated before conversion to image appearance coordinates as illustrated at (iv), prior. Then the xCAM processes, illustrated as (v), incorporating device, viewing environment, and color space parameters, convert the image to an image appearance representation providing the various color and contrast image appearance attributes as outputs.

Image appearance qualifiers, described above and illustrated at (vi), may be independently applied to each of the image A and B images. Multiple qualifiers can be applied to each image. For example an image chromatic or chromatic contrast qualifier can be made within a region qualification, meaning that the displays are only showing the selected contrast qualifier for those image pixels within the region specified. Multiple image qualifiers cannot be made which are mutually exclusive. For example, an image sharpness qualification based on perceptual threshold contrast cannot be made with a suprathreshold contrast qualification. Image qualifications may, but need not, be applied.

Image appearance-based operations, described above and illustrated as (vii), may also be independently applied to the A and B image pipelines. Operations operate on either one or both images. Image appearance difference measurements necessarily involve two images, while operations including camera characterization, color space and dynamic range mapping may be single image operations. In most embodiments, operations are applied after any image qualifications may or may not have been applied. Operations include: Camera characterization using an external calibration chart and an internally stored image appearance version of that chart, an emulation of how an image would appear as viewed on a different device, viewing environment, after a given color space transcode, measuring an appearance difference of image A versus B, and color space and dynamic range mapping.

Compliance, which is illustrated as (viii) of FIG. 18, identifies and provides an indication of out-of-gamut color and white point for a given color space through the image appearance, and the light and color displays.

The display build portion, illustrated as (ix), is responsible to construct the image appearance and light and color displays. The light and color displays are built based on image appearance coordinates and the image appearance display is constructed by either image appearance coordinates for all of the non-image display modes and device coordinates are used for the image display mode. The construction of the displays is described in more detail below.

Section (x) of FIG. 18 illustrates changing the xCAM information back to device coordinates. As with any color work flow, the working image representation model needs to be converted to device coordinates for display on a digital presentation device or a printed media so that the user may view them. In this embodiment, a unique method to achieve inversion is applied, described in the xCAM section, to tristimulus xyz, and then device coordinates via a characterization of an output device. If the output device is a printed image, then information about the specific media and ink combination to perform the final transformation is used. The image is adjusted for either a monitor or printed media so it will display intended appearance. For example, if an operation emulating how an image would appear in digital cinema has been applied, the image will be adjusted to carry the appearance of that emulation to a reference monitor as closely as possible within that monitor's constraints of producible brightness, gamut, and dynamic range. This adjustment is enabled by a significant capability of xCAM, which is that in addition to device and viewing environment independence it achieves moving image, color space, brightness and dynamic range independence.

The presentation layer, illustrated as (xi), includes displays that present to the user both image appearance and compliance information for one or two images. The image appearance display, and the light and color displays present the net of applied image qualifications and operations. In the image display mode of the image appearance display, the image has been processed to accommodate the monitor and the viewing environment in which the display is being viewed as previously described. This holds true for a tablet containing the User Interface (UI) or an external calibrated and characterized reference monitor.

The IAM provides both Serial Digital Interface (SDI) loop-through and images that have been adjusted as described above to display intended appearance on a calibrated and characterized monitor.

Details of the presentation layer, and the individual displays is now described. Three new appearance-based displays intuitively and effectively inform the desired outcomes of users from pre-visualization through mastering. The displays include an image appearance display, a light display, and a color display. All three displays are synchronized in that they present differing views of any applied image qualifiers or operations for one or both the A and B image streams. These three displays serve all of the content creation applications through the flexibility provided by the different operating modes of the image appearance display, and the synchronized Light and Color displays. These displays in combination with the functional capabilities offered by the image appearance qualifiers and operations are optimized to provide a powerful and general set of capabilities enabling appearance related actions across the workflow.

An image appearance display is one of the displays of what is termed the presentation layer. The presentation layer communicates, or presents, information about of one or more images or image sequences, or differences in images to the user. The image appearance display, in particular, provides an image-centric presentation of compliance and appearance information. The display is highly versatile in addressing a wide range of applications that is enabled by its operational modes which include an image display or true color mode, a mapped color mode, an image contrast mode, and an image detail mode.

In the image display mode, also known as the true color mode, the image appearance display shows an image that is adjusted to look “correct” on a characterized external reference monitor or the tablet containing the UI on which the content will be viewed. Correct in this context means that the image is adjusted such that it preserves the appearance information embodied in the xCAM image representation constrained by the working color space and that it incorporates a profile describing a working reference monitor in terms of its operating color space and gamma, and the local viewing environment. A simple example is in acquisition where the operational color space for a camera is in Sony S-Log with a 2.6 gamma, and the reference monitor is operating in a rec. 709 color space with a 2.2 gamma. In this case, the adjustments to the image include mapping the xCAM image representation to the display monitor's color space and gamma.

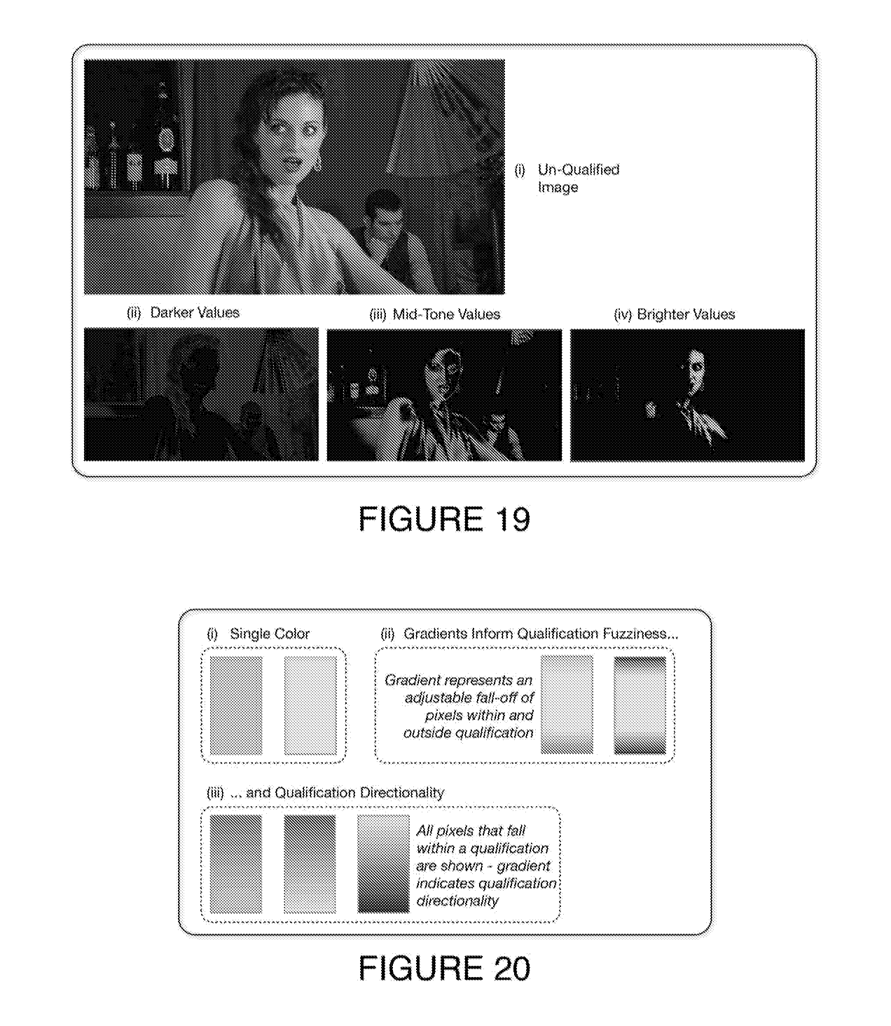

All pixels that make up an image or a subset of pixels that falls within a given qualification are displayed. This image display mode can be used in conjunction with all of the image qualifiers described above. FIG. 19 illustrates an image in the image display mode for all image pixels, illustrated at (i), and then only those image pixels that fall within three different lightness qualifications of the darker (ii), mid-tone (iii), and brighter (iv) regions of that image.

In a mapped color mode, a solid color, or gradient is mapped against image pixels that correspond to the application of one or more image qualifiers and applied operations. This configuration can be thought of as an image-centric appearance scope. FIG. 20 illustrates options for mapping solid colors or gradients to image pixels corresponding to applied qualifiers and operations.

Portion (i) of FIG. 20 illustrates mapping a solid color to pixels within a qualification or which represent an applied operation. The utility of this is to clearly indicate all pixels corresponding to applied qualifiers and or operations. A gradient can also be applied for situations in which it is desired to see the fall-off of qualified versus non-qualified pixels, or the directionality of a qualification within an image such as bright to dark. Portion (ii) of FIG. 20 illustrates two examples of using a gradient to indicate the fall-off of the edges of a qualification. The first example illustrates mapping a solid color to image pixels that are fully within a qualification and the fall-off, and the second example illustrates a color mapped against pixels fully within an image qualification and applies a gradient to pixels indicating the rate of an applied fall-off. Portion (iii) of FIG. 20 illustrates an example of using a gradient to represent the directionality from one limit of the qualification to the other limit. For example, an image qualification could include all pixels that fall within the Exposure Value (EV) range of middle grey to one stop above middle grey. In this example, a first limit is middle grey and a second limit is one EV above middle grey. An applied gradient illustrates only those pixels fully within this qualification and clearly illustrates image pixels that are at grey and one EV above, and an indication of where the remaining pixels fall along that range. The use of opponent colors for gradients can be used which provides higher chromatic contrast and therefore more granularity as the HVS does not blend opponent colors at low spatial frequencies.

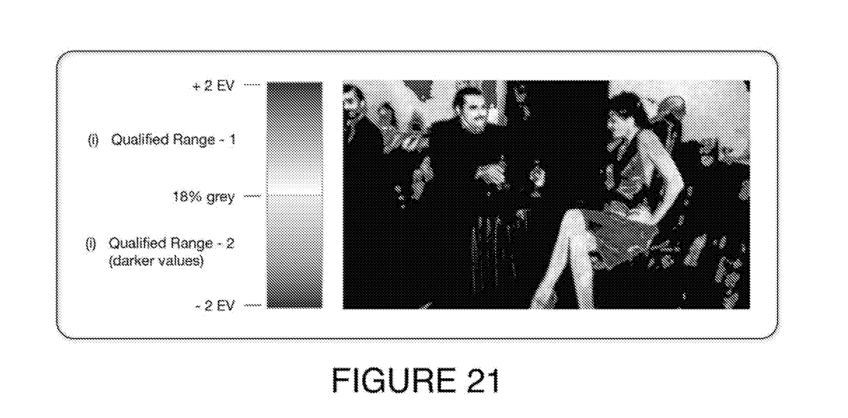

FIG. 21 illustrates an example of the utility of gradients to inform optimum camera exposure and lighting placement for a given scene. Two EV qualifiers (exposure stops) are configured corresponding to the two EV regions to an image. One qualifier is two stops above middle grey and the other is two stops below middle grey. This mode is useful for a cinematographer to manage contrast ratios across scene elements according to the well-known Ansel Adams zone system. The use of two solid colors could also be used. However, using gradients better conveys the distribution of image pixels within a given EV qualification. This is distinguished from false color implementations in several important ways:

Appearance, versus image information in device coordinates is displayed.

False color provides a gross mapping of fixed colors to different bands of luma. This implementation flexibly maps colors or gradients at the granularity of a given qualification and defined fall-offs of that qualification.

Colors and gradients can be mapped to pixels of all the image qualifiers providing essentially an image appearance “scope,” providing a visual indication of selected attributes of image appearance.

An image contrast mode of the Image Appearance Display displays an image's tonal and chromatic balance. This characterization can be selected to show broadband image achromatic or chromatic suprathreshold contrast. This capability is derived from the contrast signature outputs of the xCAM appearance model. This mode can also be used in conjunction with an image qualification of lightness, EV (f-stops), or perceptual stops (p-stops). p-stops correspond to a doubling of light intensity based on adapted image appearance. This mode is also particularly useful to inform adjustments to an image to achieve a match to a different reference image in terms of broadband image achromatic or chromatic contrast. This applies to two different images as would be the case in camera balance or scene matching, or frame identical images to carry a Look across the workflow and to the end-screen.

This mode has four options that determine the correlation of display coordinates to image coordinates along the vertical and horizontal axes. These options include:
Display pixels are vertically and horizontally uncorrelated to image pixels.
Display pixels are vertically correlated to image pixels.
Display pixels are horizontally correlated to image pixels.
Display pixels are vertically and horizontally correlated to image pixels.

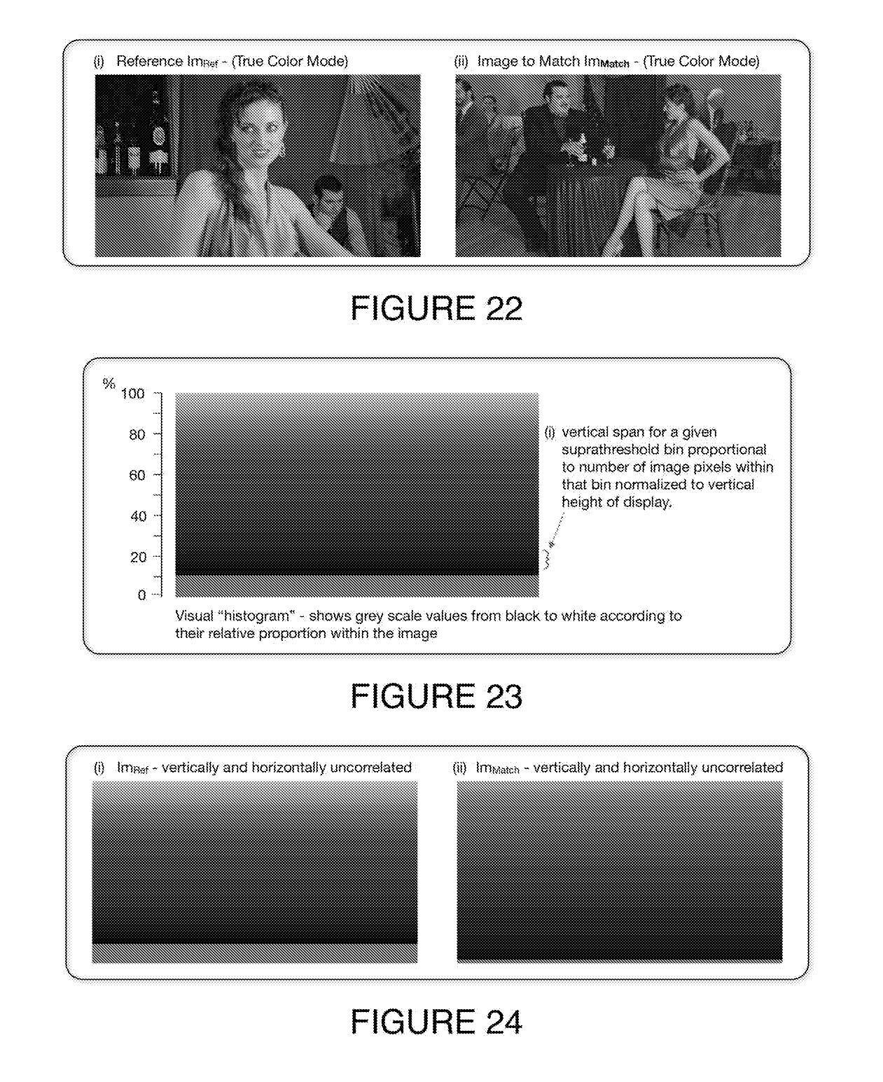

The utility of these options is demonstrated for a scene matching application shown in FIG. 22, in post-production. The image contrast mode and its four options help to quickly inform image adjustments to ImMatch, illustrated as (ii) of FIG. 22, to match ImRef, which is illustrated as (i) of FIG. 22, in terms of selected achromatic or chromatic suprathreshold image contrast. For this example, it is desired to achieve an appearance match in terms of achromatic suprathreshold image contrast. The vertically and horizontally uncorrelated option will be used to illustrate this application.

ImRef and ImMatch are shown in the true color mode in FIG. 22. A visual inspection of ImMatch shows that it is darker overall, has a green cast that shows up as grey in this black and white diagram, and is not as colorful as ImRef. Even though the two images contain different elements they can be made to appear as though they are part of the same scene by first scaling the achromatic tonal balance of ImMatch to match that of ImRef, correcting the color cast of ImMatch, and then making any final adjustments to ImMatch to ensure an appearance match of chromatic and achromatic contrast. The Light and Color displays inform the second two steps. This example focuses on achieving an appearance match in terms of the image's tonal balance.

The image contrast mode enables these adjustments to be made more quickly and effectively than alternative methods including automated scene matching software such as provided with Apple's FCP X. The efficacy of such automated scene matching utilities is limited by their device independent image representation models and thus are generally not used for professional content. With high-value production content, the most widely used practice today is to match images by eye on a properly set-up monitor and viewing environment. While this is generally effective, it is time consuming and can be tedious. Also, a colorist must take care to manage adaptions that take place for them that result from working a project in segments, which is desynchronized with how end-viewers see the film from start to finish. Thus adaptions impacting chromatic and tonal balance are different for the colorist versus the end-viewer.

In a given project the appearance or Look for representative clips of movie scenes may take 30% of the time, with the remainder spent on carrying established appearances across clips for scene matching and managing the overall arc of the appearance across the movie. The IAM facilitates carrying the appearance of an established Look more efficiently and accurately from an appearance perspective.

The first step a colorist might take would be to adjust the gain of ImMatch in the dark, mid-tone, and brighter parts of the image to achieve an overall tonal match to ImRef. The two options in which display coordinates are vertically uncorrelated to image coordinates are useful in that they directly inform these gain adjustments. This application will be described using the vertically and horizontally uncorrelated option. The other display to image correlation options help to fine tune adjustments which will then be described.

FIG. 23 shows the Image Appearance Display in the achromatic suprathreshold image contrast mode in the vertically and horizontally uncorrelated option for ImMat. Pixels are monotonically sorted in bins vertically from black to white in proportion to their relative density within the image. It can be thought of as a visual histogram of perceptual contrast with some important distinctions.

First, the bin sizes are variable. The granularity of a bin is determined by Suprathreshold versus threshold contrast. Suprathreshold response is a function of image spatial frequency, image structure, and viewing distance, which will vary across the image. This option provides what can be thought of as a suprathreshold histogram. This histogram is mapped to the display in the following manner. For each bin k, the pixel count is normalized to the total pixel count by Pix_binₖ/Pixₜₒₜₐₗ. For an image appearance display of a given vertical resolution with r rows, the number of rows which takes the value of binₖ is (Pix_binₖ/Pixₜₒₜₐₗ)*r. A selectable color, for example, blue, indicates the number of image pixels that fall outside the lowest (black) and the highest (white) perceivable suprathreshold contrast levels. In FIG. 23 it can be plainly seen that darker values make up a higher percentage of total image pixels in Im_{Mat}.

As previously noted, the Image Appearance display in the contrast mode can also be used in conjunction with EV or p-stop qualifiers. This allows for control over the black to white range of interest in terms of stops, which is a familiar working model for cinematographers. In this case the construction is similar to that described above. The resulting histogram is normalized to the total display pixels with an indication of the lightness levels provided on the vertical axis which corresponds to the qualification.

FIG. 24 illustrates both Im_{Ref} and Im_{Match} with display coordinates horizontally and vertically uncorrelated to image coordinates. The advantage of vertically and horizontally de-correlating display coordinates from the image coordinates is that it more directly informs primary image gain adjustments to the dark, mid-tone, and bright regions of the image. FIG. 24 (ii) illustrates the direct way in which the Image Appearance display conveys that Im_{Match} is darker compared to Im_{Ref}, which is consistent with the visual inspection of the original images of FIG. 22.

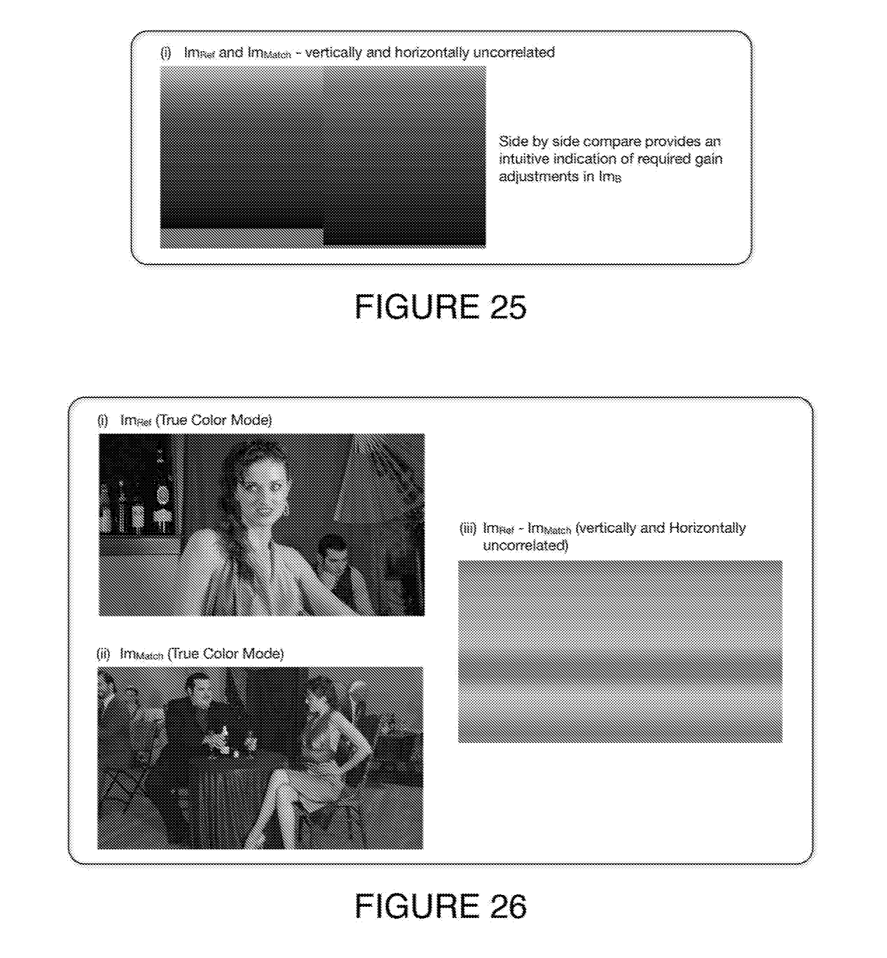

The image appearance display can be set to display a side by side comparison of Im_{Ref} and Im_{Match} as shown in FIG. 25, providing a clear visual indication of differences of the images in terms of overall brightness. This enables a colorist to quickly match Im_{Match} to Im_{Ref} with the appropriate gain adjustments across the dark, mid-tone, and brighter regions of the image.

As the previous example illustrates, the image contrast mode is particularly useful to inform image adjustments to achieve an appearance match of two frame identical or two different images. FIG. 26 shows both Im_{Ref} and Im_{Match} in a black and white version of the true color mode and FIG. 26 (iii) illustrates the image appearance difference of Im_{Ref}−Im_{Match} in the horizontally and vertically uncorrelated option prior to any corrections applied to Im_{Match}.

The IAM is first set to apply an image appearance difference operation of Im_{Ref}−Im_{match}. As described with reference to the Light and Color displays, using an image appearance difference operation has the additional benefit in that these displays show image difference, which helps to inform specific gain adjustments across the lightness axis. The presentation and construction of the appearance difference of two images differs from that of one. When applied to one image, the number of vertical display lines representing suprathreshold adjusted lightness values in a given bin were proportional the number of pixels in that bin relative to total image pixels. When displaying image appearance difference bins along the vertical axis are scaled and fixed to represent the full dynamic range of the reference image such that there is a one to one correspondence to the contrast distribution of the reference image. For example, the mid contrast adjusted lightness value on the vertical axis for image appearance difference is the same as the mid lightness value of the reference image.

The interpretation of an image appearance difference operation displayed in the contrast mode is as follows. Darker portions of the image indicate that Im_{Match} is darker compared to Im_{Ref}, with the value of darkness proportional to the magnitude of the difference. Conversely, lighter portions of the image indicate that Im_{Match} is brighter compared to Im_{Ref}, with brightness proportional to the difference. A perceptual match along a selected form of contrast of the two images is indicated by a selectable color which in FIG. 26 (iii) is grey, but would appear blue on a color screen. A solid color along the bottom of the display still corresponds to values below a perceivable suprathreshold level.

The other three options of the image contrast mode provide varying degrees of correlation of display coordinates to image coordinates along the vertical, horizontal, or both dimensions. Their application and advantages will be described.

These different correlation options for display to image coordinates help an artist fine tune image adjustments with secondary corrections. For example, vignettes are often used to darken unimportant areas of the image, often along its perimeter. This results in a center region of interest with its contrast profile and a darker region on the left and right sides of the image with a different contrast profile. The horizontally and vertically uncorrelated option described above would inform a balance of the overall image, but it would not inform the proper adjustments to match contrast across these two regions of the image. A region qualifier of the portion of the image of interest could be made, which would define the pixels to populate the image appearance display. Alternatively, or in conjunction with a region qualification, these other correlation options provide a method to focus in on the regions of the images of interest. As with the previous example of the vertically and horizontally uncorrelated option, each of these options can be used to analyze a single image or display the image appearance difference of two frame identical or different images.

The horizontally correlated option helps an artist to understand the distribution of how an image's tonal contrast varies across the image from left to right. This is useful in the case described above where the left and right portions of the image are darker. This option can be used to achieve a match across these two distinct regions of the image. Its construction is similar as described for the vertically and horizontally uncorrelated option. The vertical axis represents image pixels that are monotonically sorted from black to white with the bin sizes a function of image specific suprathreshold boundaries and the relative density of values from black to white. The difference is that there are now many of these vertical slices across the horizontal axis. Horizontal segment bins which define these slices can be derived from the image in which the aggregate contrast values of Hbinn+1 cross a suprathreshold value with respect to the aggregate contrast values of Hbinn, or they can be specified in an arbitrary manner.

The vertically and the vertically and horizontally correlated options derive their construction through an extension of the method described for the horizontally correlated option above. The vertically correlated option helps a colorist to understand variation of image contrast across the vertical dimensions. In this case the monotonically suprathreshold sorted contrast values run along horizontal bins with the vertical bins are defined as Vbinn+1 cross a suprathreshold value with respect to the aggregate contrast values of Vbinn.

The vertically and horizontally correlated option allows a colorist to see the tonal distribution across the image which is useful to help them see how their primary and secondary image adjustments impacts the tonal or chromatic balance across the image as a whole. When displaying image appearance difference this option provides the most informative indication that a match has been achieved. A simple application is to set overall gain to ImMatch using one of the vertically uncorrelated options and then using this option to check for a full tonal match across the image fine tuning adjustments as necessary.

An Image Detail mode of the image appearance scope has at least two applications. One is to inform an appearance match in terms of perceived image sharpness, and other is to inform critical focus and focus pulls. The latter application is particularly helpful as image format resolutions such as 4K exceed on camera optics and/or detail that can be seen at a given camera monitor size and viewing distance. An image can be qualified by, for example, up to three regions of perceived sharpness. These are image elements with the sharpest level of perceived detail such as the eyes of an actor, the in-focus region corresponding to depth of field, and the remainder of the image in soft focus to out-of focus. Selectable sharpness and fall-off criteria can be set to delimit the regions enabled by the achromatic threshold contrast signature outputs provided by xCAM. The image detail qualification is based on cycles per viewing angle. The Image Appearance scope can be used in conjunction with an external calibration chart used to assess the degree of image sharpness that can be achieved for a specific camera system comprising optics, sensor capabilities at its current gain setting, and image format, specific to a given lighting set-up and camera placement. This enables more intuitive image sharpness qualifications by calibrating the sharpness qualifiers to the capabilities of the camera system as described.

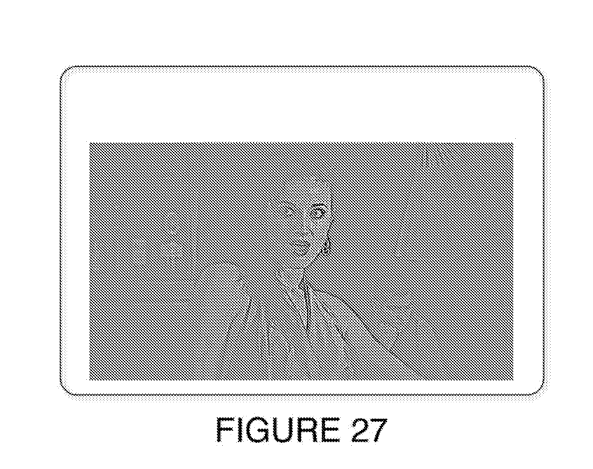

Qualified regions of perceived sharpness can be shown individually or in combination. For example, for a focus pull it would be advantageous to show only the sharpest points of focus with a definable fall-off to remove unwanted detail as illustrated in FIG. 27. This allows a camera operator to track the most important scene elements in motion without the distraction of seeing everything. For more static shots, understanding which parts of the image fall within the sharpest point of focus, the depth-of-field, would be most useful. Image detail qualifications can be displayed in either the mapped color mode or the image display mode. While mapped colors can help inform focus adjustments ultimately the cinematographer, camera operator or assistant camera operator wants to see what he or she is capturing as an image, which is the benefit of using the image display mode.

The perceptual Light and Color displays play a companion role to the Image Appearance display, all of which inform different aspects of a given image and any of its applied qualifiers or appearance operations. While the Image Appearance display provides an image-centric presentation of appearance data, exclusive of some of the suprathreshold contrast modes, the perceptual Light and Color displays indicate the image's relative color appearance attributes of hue, chroma, and lightness. The utility of the Light and Color displays is to enable an at-a-glance understanding of the distribution of perceptual color along the black to white lightness axis to quickly inform appropriate image adjustments.

All three displays represent appearance incorporating relevant adaptions specific to the application and applied qualifiers and operations. This includes scaling the relating image appearance attributes of lightness, hue, and chroma to brightness, and incorporates appearance effects of an images spatial structure and frequency and temporal dynamics, and viewing geometry.

At least two features differentiate the perceptual Light and Color displays over previous displays.

They depict adapted appearance information and can be manipulated to enable an artist to quickly see and understand the full distribution of color along blacks to whites. For example, if an image has a cast it is easy to quickly determine the extent of the cast along the Lightness range.

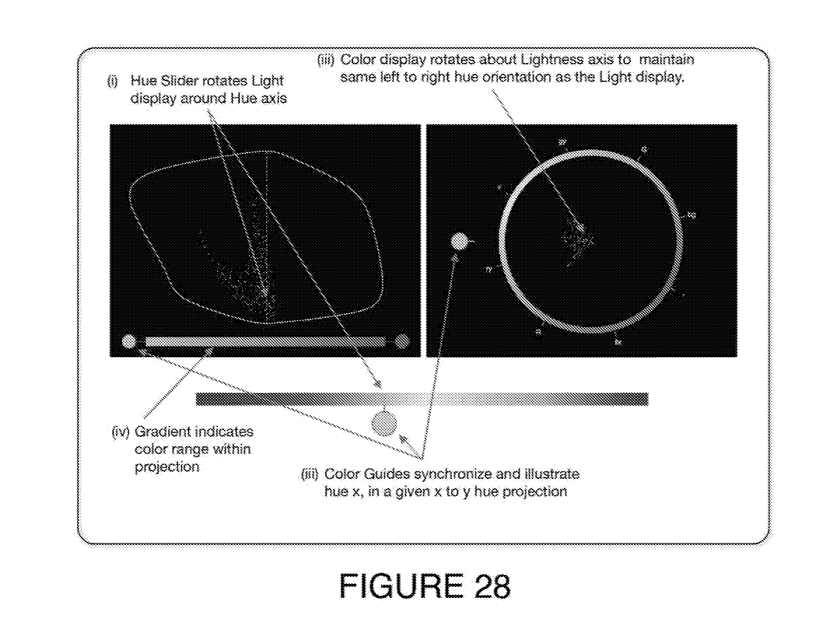

The Light display, FIG. 28 (i), and the Color display, FIG. 28 (ii), display flattened and orthogonal projections of the three dimensional space defined by an images hue, chroma and lightness content. The Light display is orthogonal to the hue axis, FIG. 28 (iii), and depicts lightness and chroma. The Color display is orthogonal to the lightness axis, FIG. 28 (iv), and depicts hue and chroma.

A hue slider, FIG. 28 (v), rotates the flattened projection of the Light and Color displays around their respective axes. This allows a user to easily and quickly find the most useful orientation of the display projections appropriate for the task at hand. Color guides, FIG. 28 (vi), help to both set and remind a user of the current orientation. This is further assisted by a color gradient under the Light display, FIG. 28 (vii), which shows the span of hue across the selected display projections.

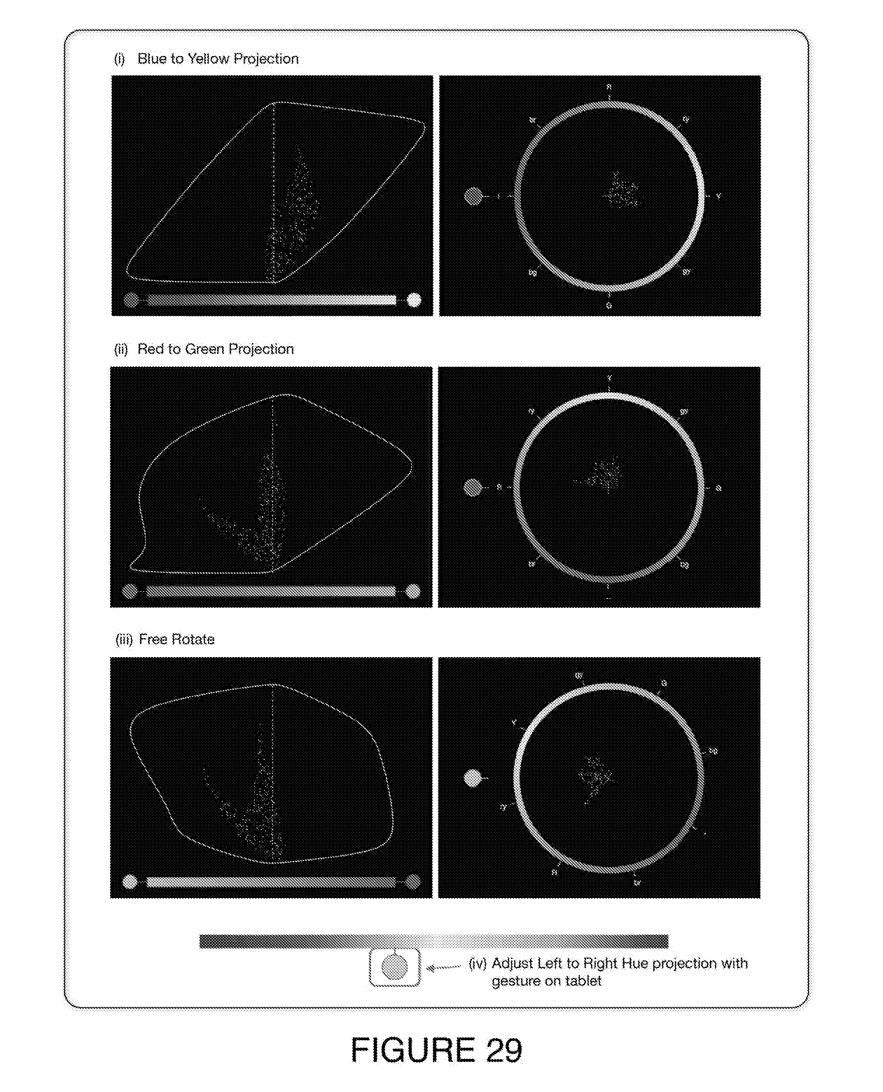

FIG. 29 illustrates an example of adjusting the Light and Color displays for three different projections. The two projections of blue to yellow, FIG. 29 (i), and red to green, FIG. 29 (ii), are the opponent visual primaries and can be set through a button selection. Of course in this illustration they are shown as shades of grey, but would appear in color on a color monitor. The hue slider, FIG. 29 (iii), described above can be used to select any projection off the two displays as illustrated FIG. 29 (iv). In this free rotation mode a working projection can be saved and recalled. The interaction design section illustrates more aspects of the usability of this implementation. Although specific embodiments of the invention have been illustrated and described for purposes if illustration, it will be understood that various modifications may be made without departing from the spirit and scope of the invention. Accordingly, the invention should not be limited except as by the appended claims.

What is claimed is:

1. A test and measurement instrument for viewing and controlling a set of related moving images, the instrument comprising:
a set of inputs including a first set of related moving images, a second set of related moving images, and a set of parameters including at least color parameters, device parameters, and view parameters;
a first image appearance processor structured to convert at least one of the first or second set of related moving images from a set of device coordinates for a first display device to a set of image appearance coordinates that account for appearance effects of human vision system adaptations;
a qualifier having an input coupled to an output of the image appearance processor and structured to apply user defined qualifications that cause the instrument to select or deselect one or more of a plurality of attributes of the sets of inputs; and
a second image appearance processor structured to convert an image to be displayed by the test and measurement instrument from the set of image appearance coordinates used by the first image appearance processor to a set of device coordinates for a second device; and
a display output structured to generate a visual display of the output from the second image appearance processor.

2. The test and measurement instrument of claim 1, further comprising:
a comparator coupled to the output of the qualifier and structured to create a difference image between the first set of related moving images and the second set of related moving images, the difference image created only for the selected qualifications and not for the non-selected qualifications; and
in which the display output is structured to generate a visual display of the created difference image between the first set of related moving images and the second set of related moving images.

3. The test and measurement instrument of claim 1 in which the display output is a wireless output operationally coupled to a wireless display device for viewing the visual display.

4. The test and measurement instrument of claim 1 in which the display output is also structured to generate a light display that presents information about the perceptual lightness and chroma of at least one of the first or second sets of related moving images.

5. The test and measurement instrument of claim 4 in which the display output is also structured to generate a color display that presents information about the perceptual hue and chroma of at least one of the first or second sets of related moving images.

6. The test and measurement instrument of claim 4 in which the light display and the color display are related to one another, the test and measurement instrument further comprising a user control structured to accept a user input and then modify the light display and the color display in concert based on the user input.

7. The test and measurement instrument of claim 1, further comprising:
a set of user controls; and
a set of operations that may be selected by a user through the user controls, the set of operations including performing a camera characterization, emulating one of the sets of related moving images on a display having particular characteristics, tonal mapping, and gamut mapping.

8. The test and measurement instrument of claim 1 in which the user defined qualifications comprise one or more of the group consisting of chromatic contrast, brightness, spatial region, region of focus, range of perceived sharpness, and achromatic suprathreshold contrast.

9. The test and measurement instrument of claim 1 in which the suprathreshold contrast is expressed in terms of a measure of perceived doubling of light.

10. A method for creating a set of viewing characteristics of a set of related moving images in a framework that accounts for appearance effects of human vision system adaptations, the method comprising:
receiving the set of related moving images;
retrieving a set of parameters including at least color parameters, device parameters, and view parameters;
converting the set of related moving images from a set of device coordinates for a first display device to a set of image appearance coordinates that account for appearance effects of human vision system adaptations;
accepting one or more user defined qualifications;
applying the user defined qualifications to select or deselect one or more of a plurality of attributes of the converted set of related moving images;
generating an output image based at least in part by the selected plurality of attributes;
re-converting the output image to be displayed from the set of image appearance to a set of device coordinates for a second display device; and
generating the output image.

11. The method of claim 10, wherein the set of related moving images is a first set of related moving images, the method further comprising:
accepting a second set of related moving images;
comparing the first set of related moving images to the second set of related moving images; and
creating a difference image based on the comparison of the first and second sets of images.

12. The method of claim 10, wherein the set of related moving images is a first set of related moving images, the method further comprising:
accepting a second set of related moving images; and
generating a light display that presents information about the perceptual lightness and chroma of at least one of the first or second sets of related moving images.

13. The method of claim 12, further comprising:
generating a color display that presents information about the perceptual hue and chroma of at least one of the first or second sets of related moving images.

14. The method of claim 13, further comprising:
accepting a user control input; and
modifying the light display and the color display in concert based on the user input.

15. The method of claim 10 in which accepting one or more user defined qualifications comprises accepting one or more of the group consisting of chromatic contrast, brightness, spatial region, region of focus, range of perceived sharpness, and achromatic suprathreshold contrast.

16. The method of claim 15 in which the suprathreshold contrast is expressed in terms of a measure of perceived doubling of light.
